(19) United States
(12) Patent Application Publication
(10) Pub. No.: US 2012/0214592 A1
(43) Pub. Date: Aug. 23, 2012

(54) GAME SYSTEM, AND CONTROL METHOD OF CONTROLLING COMPUTER AND STORAGE MEDIUM STORING COMPUTER PROGRAM USED THEREOF

(75) Inventors: Takao YAMAMOTO, Minato-ku (JP); Masahiro KIYOMOTO, Minato-ku (JP); Yoshitaka NISHIMURA, Minato-ku (JP); Shota KATAGIRI, Minato-ku (JP)

(73) Assignee: KONAMI DIGITAL ENTERTAINMENT CO., LTD., Tokyo (JP)

(21) Appl. No.: 13/396,990

(22) Filed: Feb. 15, 2012

(30) Foreign Application Priority Data
Feb. 21, 2011 (JP) 2011-034806

(51) Int. Cl. A63F 13/00

(52) U.S. Cl. 463/31

(57) ABSTRACT

A game system displays a game area in which baseline portions arranged at a distance away from each other are set on a game screen, moves and displays an operation instruction indicator for indicating an operation to a operation portion in the game area so that the operation instruction indicator arrives at least one of the baseline portions at an operation time indicated by sequence data, determines operation instruction indicators to which a question text and a answer text described in question data should be respectively assigned according to a predetermined condition, and, outputs at least one of the question text and the answer text that should be assigned to the operation instruction indicators determined in association with the operation instruction indicators.

### CROSS REFERENCE TO RELATED APPLICATION

This application claims priority to Japanese Patent Application No. 2011-034806, filed Feb. 21, 2011, the disclosure of which is hereby incorporated by reference in its entirety.

### TECHNICAL FIELD

The present invention relates to a game system that indicates an operation time of an operation portion provided on an input device to a player, and a control method of controlling a computer and a storage medium storing a computer program used thereof.

### BACKGROUND ART

There is a game machine in which plural players alternately operate operation portions in rhythm to music. Such a game machine is known in which plural players plays, a player who operates the operation portion next is determined by the operation of the operation portion, and the players alternately operate the operation portion (for example, see Patent Literature 1). Also, a game machine is known in which two players play to alternately send back an object that indicates an operation time and the speed of the object moving from one player to the other player changes according to the position of the object when the one player sends the object back (for example, see Patent Literature 2). Patent Literature 1: Japanese Patent Application Laid-Open No. 2003-236243 and Patent Literature 2: Japanese Patent Application Laid-Open No. 2000-155543.

### SUMMARY OF INVENTION

### Technical Problem

In game machines of both Patent Literature 1 and Patent Literature 2, a light bullet or an object used as an operation instruction indicator that indicates an operation of an operation portion only has a function as a device to indicate the operation portion to a player.

Therefore, an object of the present invention is to provide a game system that can cause an operation instruction indicator for indicating an operation time of an operation portion to function as a device for displaying various information, a control method of controlling a computer used thereof, and a storage medium storing a computer program.

### Solution to Problem

A game system of the present invention comprises: a display device (3) that displays a game screen (50); an input device (5) having at least one operation portion; a sequence data storage device (20) that stores sequence data (28) in which an operation time to the operation portion during a game is described; a question data storage device (20) that stores question data (29) in which one question text (QT) that should be displayed to a player and at least one answer texts (AT) corresponding to the question text are described in association with each other; a game area display device (10) that displays a game area (52) in which plural baseline portions (55A, 55B) arranged at a distance away from each other are set on a game screen of the display device; an indicator display control device (10) that moves and displays an operation instruction indicator (60) for indicating an operation to the operation portion in the game area so that the operation instruction indicator arrives at least one of the baseline portions at an operation time indicated by the sequence data; a text assignment determination device (10) that determines operation instruction indicators to which the question text and the answer text described in the question data should be respectively assigned according to a predetermined condition; and a text output device (10) that outputs at least one of the question text and the answer text that should be assigned to the operation instruction indicators determined by the text assignment determination device in association with the operation instruction indicators.

According to the present invention, the question text and the answer text corresponding to the question text are outputted in association with the operation instruction indicators according to a predetermined condition. Thereby, it is possible to cause the operation instruction indicators to function as devices that display various information such as information of the question text and information of the answer text corresponding to the information of the question text. The operation instruction indicators are caused to function as devices that display various information such as information of the question text and information of the answer text corresponding to the information of the question text, and thereby it is possible to exchange questions between players by using the operation instruction indicators that are moving corresponding to the operation time. Therefore, since new game elements are added, it is possible to improve the interest of the game.

In an aspect of the game system of the present invention, the text output device may realize the associated output by respectively displaying the question text and the answer text in predetermined positions in the game area so that the operation instruction indicators determined by the text assignment determination device and at least one of the question text and the answer text that should be assigned to the operation instruction indicators have a predetermined positional relationship with each other. In this case, since each text is displayed in a predetermined position, it is possible to cause the player to easily recognize the content of the text.

In the aspect in which each text is displayed in a predetermined position, the predetermined position may be any position. For example, in an aspect of the game system of the present invention, the text output device may set a text area (TR) for displaying either the question text or the answer text, and arrange the text area in a position behind the operation instruction indicator to which at least one of the question text and the answer text is assigned as the predetermined position. In this case, it is possible to clarify the correspondence relationship between the operation instruction indicators and the texts. In this aspect, the text output device may move the text area so as to follow the operation instruction indicator in front of the text area. Thereby, it is possible to clarify the correspondence relationship at all times even when the operation instruction indicator is moving.

Any condition may be used as the predetermined condition for the text assignment determination device to determine the operation instruction indicators to which the text should be assigned. For example, in an aspect of the game system of the present invention, the text assignment determination device may determine a predetermined operation inputted into the input device as the predetermined condition, and determine the operation instruction indicators to which the question text and the answer text should be respectively assigned by using the predetermined operation. In this case, it is possible to assign the texts to the operation instruction indicators according to the predetermined operation.

The operation portion provided in the input device is not limited to one. For example, in an aspect of the game system of the present invention, the input device is provided with plural operation portions, operation times to each of the plural operation portions during the game and information indicating one of the plural operation portions are described in association with each other in the sequence data, the game area display device displays a game area in which the plural baseline portions is set respectively so as to correspond to the plural operation portions on the game screen of the display device, and the indicator display control device may move and display the operation instruction indicator in the game area so that the operation instruction indicator arrives at the baseline portion corresponding to the operation portion associated with the operation time indicated by the sequence data at the operation time.

In the aspect in which the input device is provided with plural operation portions, it is possible to freely determine the operation instruction indicator to which the question text should be assigned. For example, in an aspect of the game system of the present invention, the input device is further provided with at least one specific operation instruction portion (A, B, C, D) for each of the operation portions, the question text is described in association with the specific operation instruction portion in the question data so that it is possible to determine which operation portion of the operation portions the question text corresponds to, and the text assignment determination device uses an operation to the specific operation instruction portion as the predetermined condition, determines a question text and a baseline portion corresponding to the specific operation instruction portion on which the operation is performed on the basis of the question data, and may determine an operation instruction indicator that arrives at the baseline portion corresponding to the specific operation instruction portion after the operation is performed on the specific operation instruction portion as the operation instruction indicator to which the question text corresponding to the specific operation instruction portion should be assigned.

In the aspect in which the input device is provided with plural operation portions, it is possible to freely determine the operation instruction indicator to which the answer text should be assigned. For example, in an aspect of the game system of the present invention, the answer text and information indicating one of the baseline portions are described in association with each other in the question data, the text assignment determination device determines an operation instruction indicator to which the question text should be assigned and determines a baseline portion at which an operation instruction indicator to which the answer text is assigned should arrive on the basis of the question data, and may determine an operation instruction indicator that arrives at the baseline portion at which the operation instruction indicator to which the answer text is assigned should arrive after the operation instruction indicator to which the question text is assigned arrives at the baseline portion at which the operation instruction indicator to which the question text is assigned should arrive as the operation instruction indicator to which an answer text corresponding to the question text should be assigned.

Any number of answer texts may be provided for one question text. For example, in an aspect of the game system of the present invention, plural answer texts may be described in association with one of the question texts in the question data. In this case, plural answers can be prepared for one question.

In the aspect in which plural answers are prepared for one of the question texts of the present invention, the text assignment determination device determines one operation instruction indicator as an operation instruction indicator to which the plural answer texts should be assigned, the indicator display control device increases and displays the one operation instruction indicator determined by the text assignment determination device to plural operation instruction indicators (60A, 60B) which corresponds to the number of the answer texts, and which move on paths different from each other and arrive at the same baseline portion at the same operation time, and the text output device may respectively associate and output the answer texts assigned to the one operation instruction indicator with the operation instruction indicators increased by the indicator display control device. In this case, since plural texts are assigned to plural operation instruction indicators that indicate the same operation time, for example, it is possible to create a game program in which answers other than answers determined to be appropriate to the question text by a player are removed from the evaluation targets of the game.

Any device may be used as the input device. For example, in an aspect of the game system of the present invention, a touch panel arranged on the display device to cover the game area may be used as the input device.

Any aspect may be used as the game area. For example, in an aspect of the present invention, the game area display device may display an area which is formed into a rectangular shape and in which two baseline portions extending linearly are set at both ends of the rectangular shape to face each other as the game area on the screen of the display device. In this case, for example, in a match-up type game which is performed by two players respectively corresponding to the baseline portions located at both end of the rectangular shape and in which the operation instruction indicator moves between both baseline portions, it is possible to add a game element in which questions or the like are exchanged between the two players.

In an aspect of the game system of the present invention, the game system may further comprise an evaluation device (10) that evaluates an operation on at least one operation portion on the basis of a time of an operation to the operation portions and an operation time specified by the sequence data. In this case, it is possible to evaluate a time of an operation to each operation portion on the basis of an operation time described in the sequence data. Thereby, it is possible to further improve the interest of the game.

In an aspect of the game system of the present invention, the game system further comprises: an audio output device (14) that output game audio; a music data storage device (20) that stores music data for reproducing music; and a music reproduction device (10) that reproduces the music from the audio output device on the basis of the music data; and wherein an operation time of the operation portion during reproduction of the music may be described in the sequence data. In this case, it is possible to realize a music game in which the operation instruction indicator moves between the baseline portions so that the operation instruction indicator arrives at the baseline portion corresponding to an operation time at the operation time corresponding to rhythm of the music, and an exchange of questions using the operation instruction indicator can be performed.

In an aspect comprising the audio output device, the text output device may reproduce the question text or the plural answer texts assigned to each operation instruction indicator from the audio output device when the player performs an appropriate operation in accordance with a contact between the operation instruction indicator to which at least one of the question text and the answer text is assigned and the baseline portion. In this case, it is possible to cause the player to recognize the content of the text by voice.

A control method of controlling a computer (10) which is incorporated in a game system comprising: a display device (3) that displays and outputs a game screen (50); an input device (5) having at least one operation portion; a sequence data storage device (20) that stores sequence data (28) in which an operation time to the operation portion during a game is described; a question data storage device (20) that stores question data (28) in which one question text (QT) that should be displayed to a player and at least one answer texts (AT) corresponding to the question text are described in association with each other; wherein the control method of controlling the computer comprises the steps: a game area display step that displays a game area (52) in which plural baseline portions (55A, 55B) arranged at a distance away from each other are set on a game screen of the display device; an indicator display control step that moves and displays an operation instruction indicator (60) for indicating an operation to the operation portion in the game area so that the operation instruction indicator arrives at least one of the baseline portions at an operation time indicated by the sequence data; a text assignment determination step that determines operation instruction indicators to which the question text and the answer text described in the question data should be respectively assigned according to a predetermined condition; and a text output step that outputs at least one of the question text and the answer text that should be assigned to the operation instruction indicators determined by the text assignment determination step in association with the operation instruction indicators.

A storage medium of the present invention stores a computer program for a game system comprising: a display device (3) that displays and outputs a game screen (50); an input device (5) having at least one operation portion; a sequence data storage device (20) that stores sequence data (28) in which an operation time to the operation portion during a game is described; a question data storage device (20) that stores question data (29) in which one question text (QT) that should be displayed to a player and at least one answer texts (AT) corresponding to the question text are described in association with each other; wherein the computer program is configured to make a computer (10) incorporated in the game system serve as: a game area display device that displays a game area (52) in which plural baseline portions (55A, 55B) arranged at a distance away from each other are set on a game screen of the display device; an indicator display control device that moves and displays an operation instruction indicator (60) for indicating an operation to the operation portion in the game area so that the operation instruction indicator arrives at least one of the baseline portions at an operation time indicated by the sequence data; a text assignment determination device that determines operation instruction indicators to which the question text and the answer text described in the question data should be respectively assigned according to a predetermined condition; and a text output device that outputs at least one of the question text and the answer text that should be assigned to the operation instruction indicators determined by the text assignment determination device in association with the operation instruction indicators. The game system of the present invention can be realized by executing the control method or the computer program which is stored in the storage medium of the present invention.

In the above description, for ease of understanding of the present invention, reference numerals of the attached drawings are added in parentheses, however, this will not limit the present invention into the drawings.

### Advantageous Effects of Invention

As described above, according to the present invention, it is possible to cause an operation instruction indicator that indicates an operation time of an operation portion to function as a device that displays various information.

### BRIEF DESCRIPTION OF DRAWINGS

FIG. 1 is a diagram showing an example of a game machine to which a game system according to an embodiment of the present invention is applied;

FIG. 2 is a functional block diagram of the game machine;

FIG. 3 is a diagram schematically showing a game screen;

FIG. 4 is a diagram illustrating areas of an object;

FIG. 5 is a diagram schematically showing a game screen immediately before a question text is displayed;

FIG. 6 is a diagram schematically showing a game screen after a short time has passed from the game screen of FIG. 5;

FIG. 7 is a diagram schematically showing a game screen after a short time has passed from the game screen of FIG. 6;

FIG. 8 is a diagram showing an example of content of sequence data;

FIG. 9 is a diagram showing an example of content of question data;

FIG. 10 is a diagram showing an example of a flowchart of a sequence processing routine;

FIG. 11 is a diagram showing an example of a flowchart of an assignment processing routine;

FIG. 12 is a diagram showing an example of a flowchart of a path determination processing routine;

FIG. 13 is a diagram showing an example of a flowchart of an operation evaluation routine; and

FIG. 14 is a diagram showing a state in which two game machines are connected to each other so that the game machines can share content of a game.

### DESCRIPTION OF EMBODIMENTS

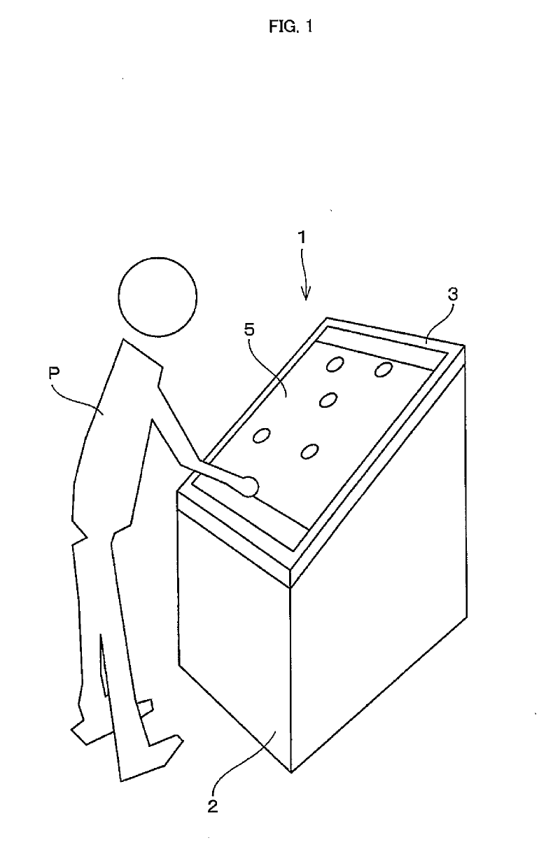

Hereinafter, an embodiment of a game system according to the present invention will be described. FIG. 1 is a diagram showing an arcade game machine for commercial use, to which a game system according to an embodiment of the present invention is applied. As shown in FIG. 1, a game machine 1 includes a housing 2 and a monitor 3 used as a display device which is disposed on the top surface of the housing 2 and tilted to face a player P side. A transparent touch panel 5 is laminated on the surface of the monitor 3. The touch panel 5 is a publicly known input device. When the player P touches the touch panel 5, the touch panel 5 outputs a signal corresponding to a position where the player P touches with a finger or other object. In addition, the game machine 1 has various input devices and output devices included in a normal arcade game machine, such as a button for selection or decision, a power switch, a volume control switch, and a power lamp. However, the input devices and the output devices are omitted in FIG. 1.

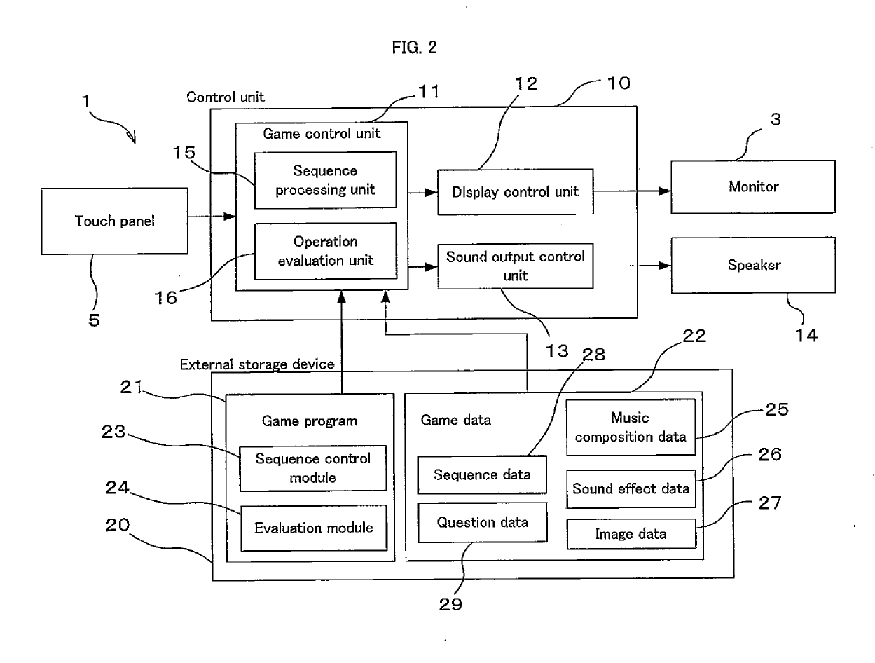

FIG. 2 is a functional block diagram of the game machine 1. As shown in FIG. 2, a control unit 10 as a computer is provided in the main body 3. The control unit 10 includes a game control unit 11 serving as a main controller, and a display control unit 12 and a sound output control unit 13, which operate according to the output from the game control unit 11. The game control unit 11 is configured as a unit formed by combining a microprocessor and various peripheral devices such as an internal storage device (for example, ROM and RAM) necessary for the operation of the microprocessor. The display control unit 12 draws an image according to drawing data given from the game control unit 11 on a frame buffer, and outputs a video signal corresponding to the drawn image to the monitor 3, thereby displaying a predetermined image onto the monitor 3. The sound output control unit 13 generates a sound reproducing signal according to sound reproducing data given from the game control unit 11 and outputs the resultant to the speaker 14 as an audio output device, thereby reproducing a predetermined sound (including music composition or the like) from the speaker 14.

An external storage device is connected to the game control unit 11. As the external storage device, there is used a storage medium which can hold the data even if power is not supplied thereto such as an optical storage medium including DVDROM or CDROM etc., or a non-volatile semiconductor device including EEPROM etc.

The external storage device 20 stores a game program 21 and game data 22. The game program 21 is a computer program necessary for executing a music game on the game machine 1 in accordance with a predetermined procedure. The game program 21 includes a sequence control module 23 and an evaluation module 24 for realizing the function according to the present invention. When the main body 3 is started, the game control unit 11 executes an operation program stored in an internal storage device so as to execute various processes necessary for operating as the game machine 1, and then, reads and executed the game program 21 from the external storage device 20, thereby setting an environment for executing the music game in accordance with the game program 21. When the game control unit 11 executes the sequence control module 23 of the game program 21, a sequence processing unit 15 is generated in the game control unit 11. When the game control unit 11 executes the evaluation module 24 of the game program 21, an operation evaluation unit 16 is generated in the game control unit 11. The sequence processing unit 15 and the operation evaluation unit 16 are logical devices realized by the combination of computer hardware and a computer program. The sequence processing unit 15 gives an instruction to the player to operate with the reproduction of the music (music composition) selected by the player, or executes a music game process of generating a production such as sound effect according to the operation by the player. The operation evaluation unit 16 executes a process that evaluates the operation of the player, controls the game according to the result of the evaluation, or the like.

In addition, the game program 21 also includes various program modules necessary for executing the music game in addition to the above-mentioned modules 23 and 24, and the game control unit 11 has logical devices corresponding to these modules. However, these devices are not illustrated in the figure.

The game data 22 includes various data pieces that should be referred to when the music game is executed in accordance with the game program 21. For example, the game data 22 includes music composition data 25, sound effect data 26, and image data 27. The music composition data 25 is data necessary for reproducing and outputting the music composition, which is the subject of the game, from the speaker 14. In FIG. 2, one type of music composition data 25 is illustrated. However, the player can actually select a music composition to be played from plural music compositions. The plural music composition data pieces 25 are recorded in the game data 22 with the information for identifying the respective compositions attached thereto. The sound effect data 26 is data in which plural types of sound effects that should be output from the speaker 14 in response to the operation of the player are recorded as associated with a unique code for every sound effect. The sound effect includes a sound of a musical instrument and various other types of sound. The sound effect data may be prepared in a predetermined octave number with a pitch changed. The image data 27 is data for displaying a background image, various objects, icons, etc. in the game screen on the monitor 3.

The game data 22 further includes sequence data 28 and question data 29. The sequence data 28 is data defining an operation or the like that should be indicated to the player. At least one sequence data 28 is prepared for one music data. The question data 29 is data in which question information asked to the player and information of answer candidate to the question information are described in association with each other. The details of the data 28 and the data 29 are described later.

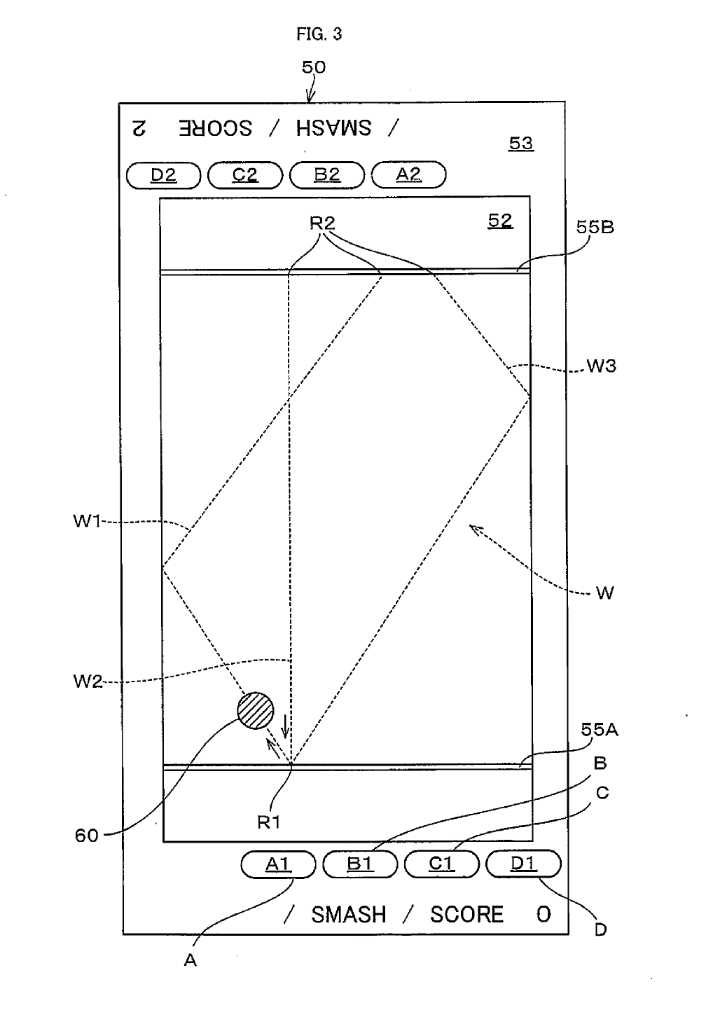

Next, an outline of the music game performed on the game machine 1 will be described. The game machine 1 is configured as a match-up type music game machine on which two players (including a case in which the game machine 1 functions as one player) operate to music and the two players are caused to compete by evaluating operation times of the two players. Although only one game machine is shown in FIG. 1, a game may be performed by the game machines 1 connected to each other so that the game machines 1 can share the state of the game. FIG. 3 is a diagram schematically showing a game screen. A game screen 50 includes a game area 52 for guiding an operation time to the player and an information area 53 for displaying scores of each players and the like. The game area 52 is formed into a rectangle shape. At both ends of the game area 52 in the longitudinal direction, a first operational baseline portion 55A and a second operational baseline portion 55B are arranged to face each other as baseline portions. The operational baseline portions 55A and 55B extend lineally in a direction perpendicular to the longitudinal direction of the game area 52. The operational baseline portions 55A and 55B are respectively used as baselines of the current time on a game by the players of the game. Specifically, the first operational baseline portion 55A is used as the baseline of the current time of a first player, and the second operational baseline portion 55B is used as the baseline of the current time of a second player. In the example of FIG. 3, a red straight line is used as the first operational baseline portion 55A and a blue straight line is used as the second operational baseline portion 55B. Also, different colors are used for each player for distinguish the players.

The information area 53 is arranged around the game area 52. In the information area 53, one end side of the game area 52 in the longitudinal direction is used to display the score of one player and the other end side is used to display the score of the other player. In the information area 53, four selection buttons A to D are provided as specific operation instruction portions for each player. Specifically, first player selection buttons A1 to D1 are arranged on the side of the first operational baseline portion 55A as selection buttons for the first player, and second player selection buttons A2 to D2 are arranged on the side of the second operational baseline portion 55B as selection buttons for the second player. The first player selection buttons A1 to D1 are arranged in the order of the first selection button A1, the second selection button B1, the third selection button C1, and the fourth selection button D1 in a left to right direction in FIG. 3. The second player selection buttons A2 to D2 are arranged in the order of the first selection button A2, the second selection button B2, the third selection button C2, and the fourth selection button D2 in the right to left direction in FIG. 3. These selection buttons A to D are used to select question information described in the question data 29. The relationship between the selection buttons A to D and the question information described in the question data 29 is described later.

The operational baseline portions 55A and 55B respectively include plural rebound points arranged at a predetermined interval. The rebound points R1 included in the first operational baseline portion 55A and the rebound points R2 included in the second operational baseline portion 55B are connected to each other by plural paths W. Specifically, plural paths W are provided from one rebound point R1 included in the first operational baseline portion 55A to plural rebound points R2 included in the second operational baseline portion 55B. Three dashed lines in FIG. 3 respectively indicate three paths W1, W2, and W3 connecting between the rebound point R1 and the rebound points R2. In the example of FIG. 3, at one rebound point R1 included in the first operational baseline portion 55A, there is provided three paths W1, W2, and W3 extending from the one rebound point R1 to three rebound points R2 included in the second operational baseline portion 55B. While a music game is being performed, in other words, while music is being reproduced, an object 60 is displayed according to the sequence data 28 as an operation instruction indicator that indicates an operation on the paths W connecting the rebound point R1 with the rebound points R2. In addition, in FIG. 3, for convenience of description, the paths W1, W2, and W3 are shown by a dashed line. However, none of the paths W are shown on the actual game screen 50.

The object 60 appears at the rebound point R1 or the rebound point R2 at an appropriate timing in music and moves from the rebound point R1 or R2 at which the object 60 appears to the rebound point R1 or R2 located on the opposite side on the path W extending from the rebound point R1 or R2 at which the object 60 appears. Then, the rebound point R1 or R2 at which the object 60 arrives becomes the next appearance position of the object 60, and the object 60 moves from the appearance position to the rebound point R1 or R2 located on the opposite side. Therefore, the object 60 alternately and repeatedly moves between the operational baseline portions 55A and 55B as if the object 60 rebounded at the rebound points R1 and R2. When the object 60 arrives at the operational baseline portion 55A or 55B, the player who uses the operational baseline portion 55A or 55B at which the object 60 arrives as a reference of the current time is required to perform a touch operation to touch the position at which the object 60 arrives on the operational baseline portion 55A or 55B. When the player performs the touch operation, a time difference between a time when the object 60 arrives at the operational baseline portion 55A or 55B and a time when the player performs the touch operation is detected. The smaller the time difference is, the more highly the operation of the player is valued. A sound effect is reproduced from a speaker 14 according to the touch operation. A known method may be used as the reproduction method of the sound effect. For example, as a known method of reproducing a sound effect, there are a method in which a sound effect is added on music while reproducing the music and a method which reproduces a sound effect corresponding to a wrong operation while muting the music when the wrong operation occurs. For example, there is also a method in which music is divided and associated with each operation time and if an appropriate operation is performed, a part of music associated with the operation is played (A method for forming appropriate music by an appropriate operation for each operation time. Therefore, if a wrong operation is performed, a part of music associated with an operation time of the operation is not played.).

In the example of FIG. 3, the object 60 is moving toward the rebound point R2 of the second operational baseline portion 55B. When the object 60 arrives at the second operational baseline portion 55B, the second player who uses the second operational baseline portion 55B as a reference of the current time touches the position at which the object 60 arrives on the second operational baseline portion 55B. The object 60 is displayed with a color corresponding to the operational baseline portion 55A or 55B toward which the object 60 is moving. Specifically, in the example of FIG. 3, the object 60 is displayed with color in blue until the object 60 arrives at the rebound point R2 on the second operational baseline portion 55B and the next object 60 which appears at the rebound point R2 is displayed with color in red. In the present embodiment, plural operation portions are formed by a combination of the operational baseline portions 55A and 55B and the touch panel 5 laminated on the operational baseline portions 55A and 55B. In addition, hereinafter, the operational baseline portions 55A and 55B may be used as words representing the operation portion.

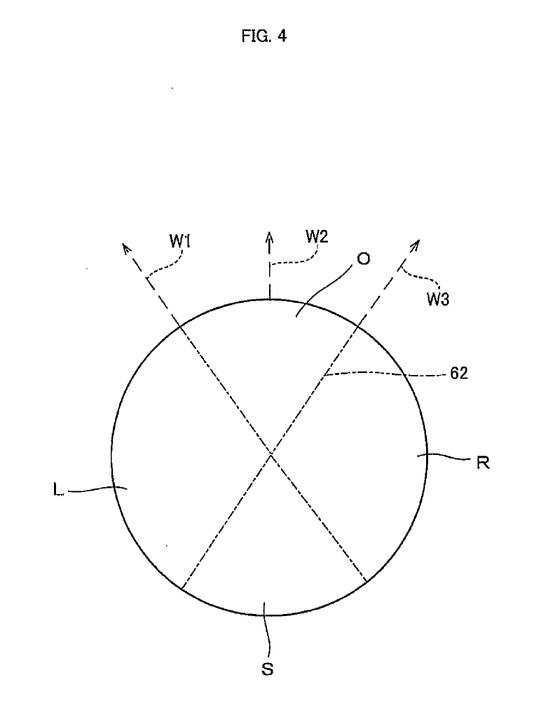

A path W for the object 60 to move from the rebound point R1 or R2 at which the object 60 arrives to the opposite rebound point R1 or R2 is determined according to the position of the object 60 when the operational baseline portion 55A or 55B is touched. To compare positions easily, the object 60 is divided into plural areas. FIG. 4 is a diagram illustrating areas of the object 60. The dashed lines in FIG. 4 indicate the paths W1, W2, and W3 respectively, and the dashed-dotted lines 62 indicate boundaries between the areas. In the example of FIG. 4, the object 60 is divided into four areas which are a contact area S that first comes into contact with the operational baseline portion 55A or 55B, a right area R and a left area L which are separated by the contact area S, and the other area O. As a path on which the object 60 moves, among the paths W from the rebound point R2 to the rebound point R1, the linear path W2 which is the shortest way to R2 is selected when an area near the contact area S or the other area O is touched, a first right path W3 which goes to R1 via the right side wall 52R in the longitudinal direction of the game area 52 is selected when an area near the left area L is touched, and a first left path W1 which goes to R1 via the left side wall 52L in the longitudinal direction of the game area 52 is selected when an area near the right area R is touched. That is, the movement path on which the object 60 moves to the next operational baseline portion 55A or 55B is determined according to the positional relationship between the operation position at which the touch operation is performed and the position of the object 60. Since the moving distance varies according to the movement path, the moving distance by which the object 60 moves to the next operational baseline portion 55A or 55B varies according to the positional relationship between the operation position and the position of the object 60. On the other hand, the operation time at which the object 60 is touched, that is, the time at which the object should arrive at the operational baseline portion 55A or 55B, is constant regardless of the movement path. Therefore, the moving speed of the object 60 varies according to the movement path. Specifically, the path W and the moving speed of the object 60 moving to one player vary according to the touch operation of the other player. Since this changes the degree of difficulty of the game, one player performs his or her operation while considering the effect of the operation to the other player.

Further, in the game area 52, when any of the selection buttons A to D is touched, a question text and an answer text are displayed behind the moving object 60. The displayed question text moves as if to follow the object 60. If an appropriate operation is performed at the timing at which the object 60 behind which the question message is displayed arrives at the operational baseline portion 55A or 55B, plural objects 60 appear at the position at which the object 60 arrives on the operational baseline portion 55A or 55B. The objects 60 move toward the same operational baseline portion to indicate the same operation time. And, answer texts that respectively move as if to follow the objects 60 are displayed behind the objects 60. In summary, when one player touches a selection button, a question text is displayed as a question to the other player. Then, the other player is required to perform an appropriate operation at the position at which an object 60 followed by an answer text considered to be the appropriate answer relevant to the content of the question text arrives by selecting the object 60 from the plural objects 60 which are followed by answer texts and arrive at the operational baseline portion at the same time. In this way, an exchange of question and answer for the question is added to the game at an appropriate timing.

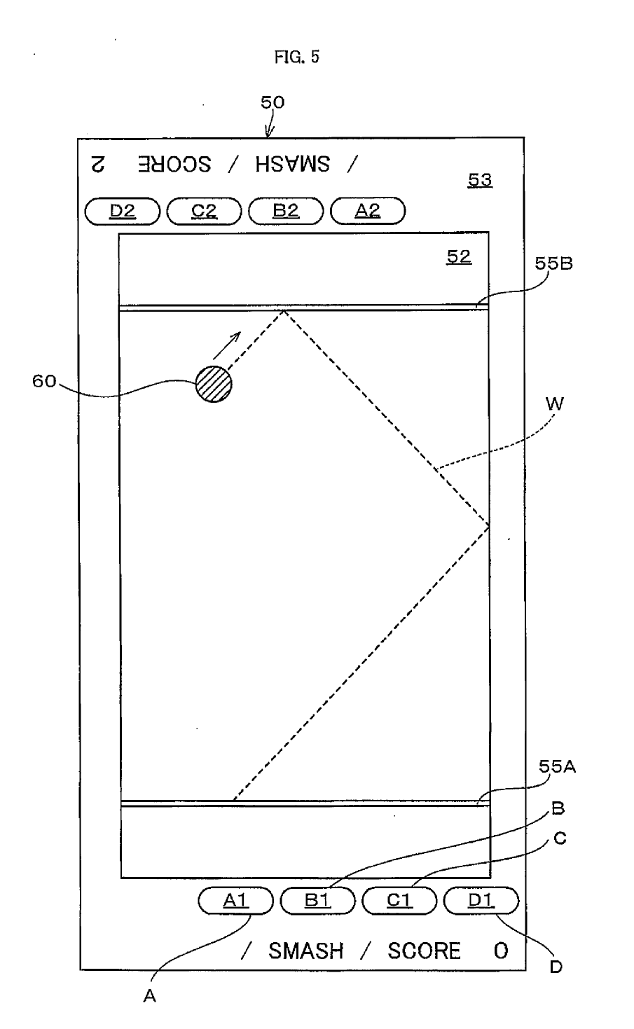

FIG. 5 is a diagram schematically showing a game screen immediately before the question text is displayed. In the example of FIG. 5, the object 60 that is moving from the first operational baseline portion 55A to the second operational baseline portion 55B is located immediately before the second operational baseline portion 55B. In this situation, if one of the first player selection buttons A1 to D1 is touched, after the object 60 arrives at the second operational baseline portion 55B, a question text is displayed behind the object 60 moving from the arrival position toward the next first operational baseline portion 55A. Further, when the object 60 arrives at the second operational baseline portion 55B, the content of the question text is reproduced from the speaker 14 by voice.

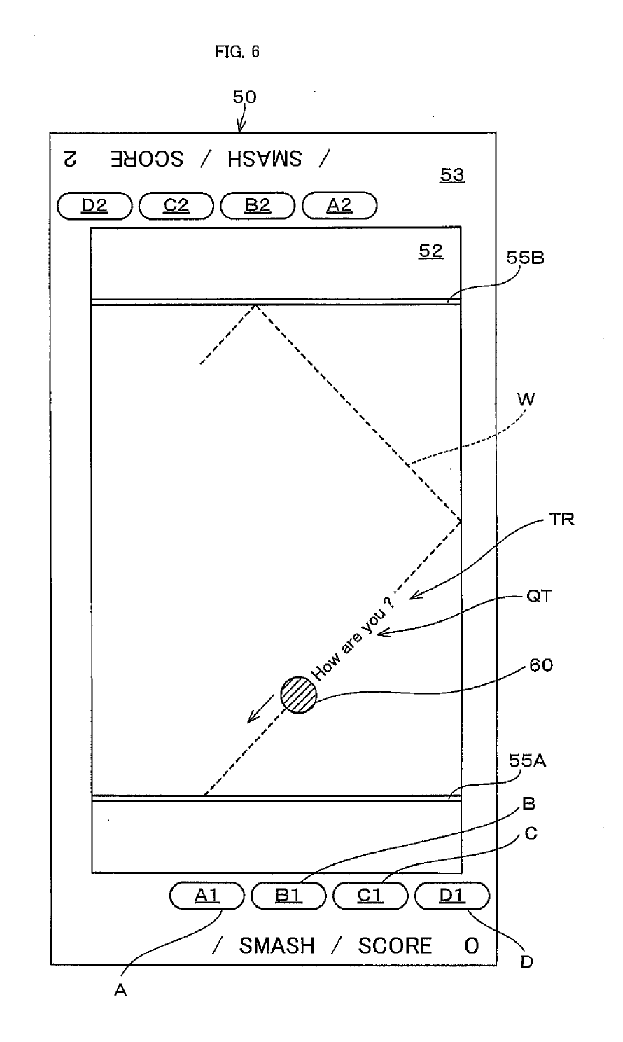

FIG. 6 is a diagram schematically showing a game screen after a short time has passed from the game screen of FIG. 5. The example of FIG. 6 shows movement of the object 60, in which the object 60 that was located immediately before the second operational baseline portion 55B in the game screen of the FIG. 5 arrives at the second operational baseline portion 55B and moves from there to the first operational baseline portion 55A. A text area TR for displaying the question text is set behind the object 60. In the text area TR, a question text QT “How are you?” is displayed. The text area TR extends along the path W on which the object 60 moves so that the head of the question text QT faces the object 60, and the text area TR moves to follow the object 60. In the example of FIG. 6, the text “How are you?” is displayed along the path W so that the word “How” of the question text QT “How are you?” is located near the object 60. The text “How are you?” moves as if to follow the objects 60 with the movement of the object 60. In addition, in the example of FIG. 6, the text “How are you?” is displayed along the path W so that the head word “How” of “How are you?” is located near the object 60 in an orientation in which the player who sends the question can easily see the text “How are you?”. However, it is not limited to this. For example, the text “How are you?” may be displayed in an orientation in which the player who receives the question, that is, the answerer, can easily see the text. For example, the text “How are you?” may be displayed along the path W so that the head word “How” is farthest from the object 60 and the tailing character “?” is located nearest to the object 60 in an orientation opposite to that in FIG. 5.

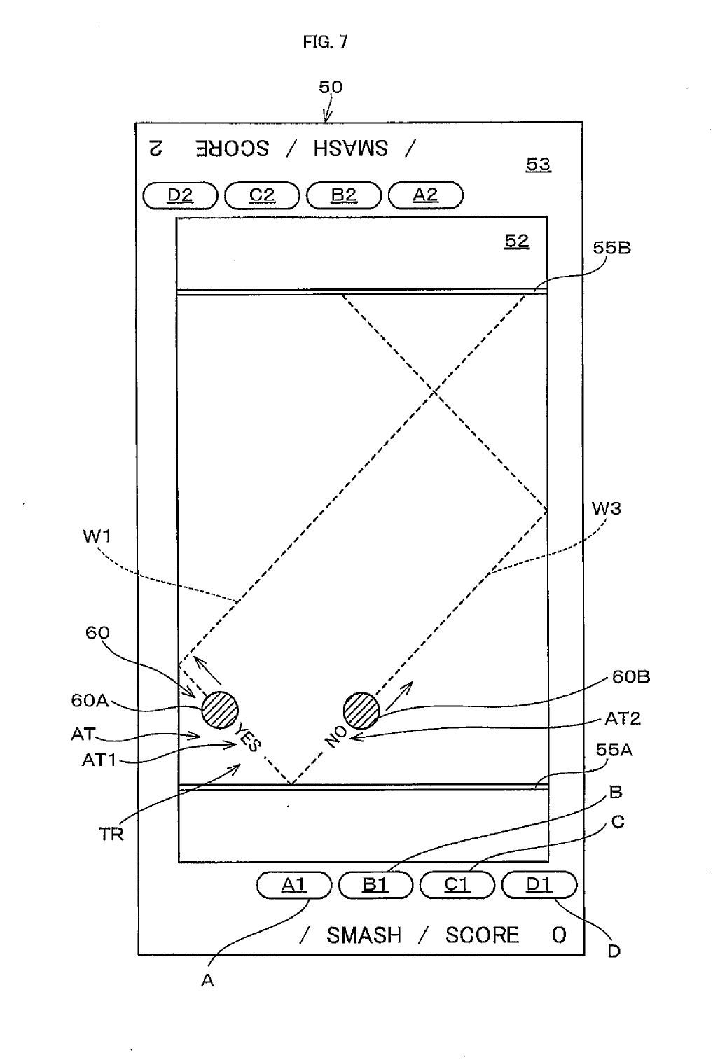

FIG. 7 is a diagram schematically showing a game screen after a short time has passed from the game screen of FIG. 6. The answer text is provided corresponding to the question text QT, and plural answer texts are provided as answer candidates to the question text. FIG. 7 shows an example in which two answer texts “YES” and “NO” are prepared as answer candidates to the question text QT “How are you?”. The example of FIG. 7 shows a state immediately after the object 60 that was moving toward the first operational baseline portion 55A in the game screen in FIG. 6 arrives at the first operational baseline portion 55A. If the position at which the object 60 arrives on the first operational baseline portion 55A is touched at an appropriate timing at which the object 60 arrives at the first operational baseline portion 55A, responding to the touch operation, two objects 60 are displayed at the position at which the object 60 arrives on the first operational baseline portion 55A as if the arriving object 60 were divided. Then, the text areas TR for displaying answer texts AT are set behind the two objects 60 respectively. Answer texts AT1 and AT2 that are respectively assigned to the text areas TR of the objects 60 are displayed in the text areas TR. Specifically, a text “YES” corresponding to the first answer text AT1 is displayed behind one object 60A moving along the first left path W1 and a text “NO” corresponding to the second answer text AT2 is displayed behind the other object 60B moving along the first right path W3.

Both of the two objects 60A and 60B move toward the second operational baseline portion 55B along the paths W1 and W3. Since the objects 60A and 60B respectively move along the paths different from each other, the objects 60A and 60B arrive at positions different from each other on the second operational baseline portion 55B. However, both of the objects 60A and 60B move in order to indicate the same operation time, so that the objects 60A and 60B arrive at the second operational baseline portion 55B at the same time. The player is required to perform an appropriate operation on an object 60 behind which an answer text AT to the question text QT “How are you?” is displayed between the two objects 60 arriving at the same time. Specifically, the player is required to determine whether “YES” corresponding to the first answer text AT1 or “NO” corresponding to the second answer text AT2 is appropriate as an answer to the question text QT “How are you?”. If “YES” is appropriate, when the one object 60A behind which “YES” is displayed arrives at the second operational baseline portion 55B, the player touches the position at which the one object 60A arrives, and if “NO” is appropriate, when the other object 60B behind which “NO” is displayed arrives at the second operational baseline portion 55B, the player touches the position at which the other object 60B arrives.

An arrival position touched on the second operational baseline portion 55B between the arrival positions at which the object 60A or 60B arrives functions as an appearance position of the object 60 which subsequently begins to be displayed. The movement path on which the object 60 moves to the next operational baseline portion is determined according to the positional relationship between the arrival position of the object 60 on which the touch operation is performed and the position at which the touch operation is performed. When the touch operation is performed on the arrival position at an appropriate timing, content of the answer text AT displayed behind the object 60 corresponding to the arrival position on which the touch operation is performed is outputted from the speaker 14 as voice. For example, the position at which the one object 60A arrives on the second operational baseline portion 55B is touched at the timing at which the object 60A arrives at the position, the voice “YES” is reproduced. Of the two objects 60A and 60B, the other object 60B on which the touch operation is not performed on the arrival position on the second operational baseline portion 55B passes through the second operational baseline portion 55B, hits the upper end portion 52U of the game area 52, and disappears.

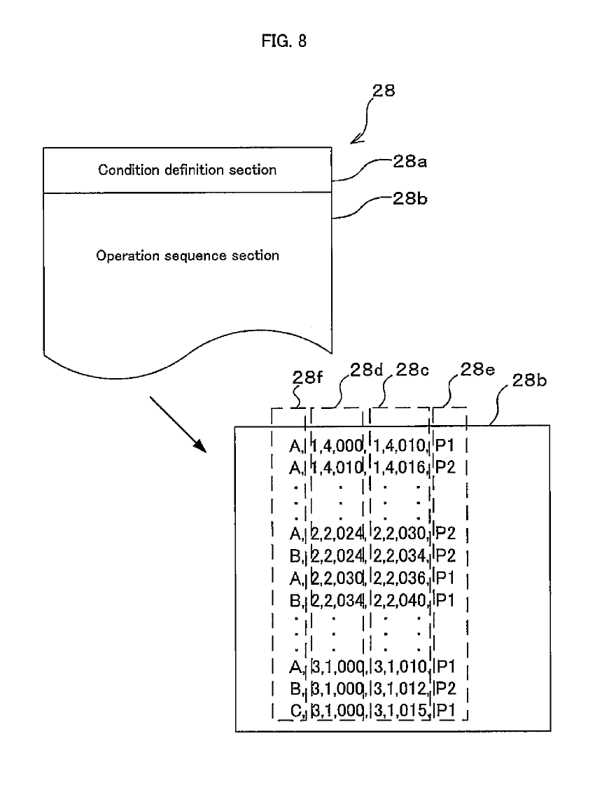

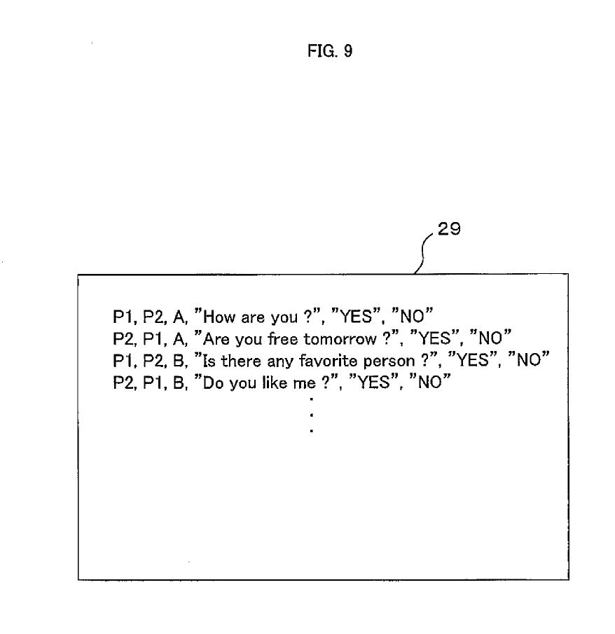

Next, the details of the sequence data 28 and the question data 29 will be described with reference to FIGS. 8 and 9. As shown in FIG. 8, the sequence data 28 includes a condition definition section 28a and an operation sequence section 28b. In the condition definition section 28a, there is described information specifying game execution conditions different for each music piece, such as tempo, beat, and track of music, and information specifying sound effects generated when the object 60 is touched. In addition, although, in FIG. 8, the condition definition section 28a is provided only at the head of the sequence data 28, the condition definition section 28a may be added to an arbitrary position in the operation sequence section 28b. Thereby, it is possible to perform processing, such as changing tempo in music and changing assignment of sound effect.

On the other hand, in the operation sequence section 28b, a time when the object 60 should be touched, a time when the object 60 should begin to be displayed, and information indicating the operational baseline portion 55A or 55B are described in association with each object 60. FIG. 8 is a diagram showing an example of content of the sequence data. As illustrated partially in FIG. 8, the operation sequence section 28b includes an operation time section 28c that indicates a time (operation time) at which an operation is performed in music, a display start information section 28d that sets a display start time at which the object 60 begins to be displayed, a display position indication section 28e that indicates the operational baseline portion 55A or 55B on which the object 60 begins to be displayed, and an indicator information section 28f that indicates the object 60 to be displayed. The operation sequence section 28b is configured as an aggregation of plural records in which the operation time at which an operation is performed in music, the display start time at which the object 60 begins to be displayed, and the operational baseline portion 55A or 55B on which the object 60 begins to be displayed are described in association with each object 60 to be displayed. In the operation time and the display start time, a measure number in music, a count of beats in music, and a time in a beat are described in a comma-delimited format. The time in a beat is a time elapsed from the start of one beat. When a time length of one beat is divided into n time units, the time in a beat is represented by the number of the time units from the start of the beat. For example, under a condition of n=100, when a time at which a quarter of a beat has elapsed from the start of the beat in the second beat in the first measure in music is specified as the operation time or the display start time, the operation time or the display start time is described as “01, 2, 025”.

An indication of the operational baseline portion 55A or 55B on which the object 60 begins to be displayed is described as “P1” when indicating the first operational baseline portion 55A and is described as “P2” when indicating the second operational baseline portion 55B. The indication of the operational baseline portion 55A or 55B also indicates colors of the object 60 to be displayed. If the indication is “P1”, a blue color object 60 is displayed. If the indication is “P2”, a red color object 60 is displayed.

In the indicator information section 28f, information that indicates the object 60 to be displayed is described with an alphabetical character such as “A”. As an alphabetical character corresponding to the first object 60 to be displayed in the game area 52, “A” is used. As an alphabetical character corresponding to the second object 60, “B” is used. As an alphabetical character corresponding to the third object 60, “C” is used. In other words, as information that indicates the object 60 to be displayed, different alphabetical characters corresponding to the number of the objects 60 to be displayed in the game area 52 are used. The information that indicates the object 60 also indicates a correspondence relationship between the operation times. Specifically, between the operation times associated with information that indicates a common object 60, a position at which an object 60 corresponding to one operation time arrives has a function as a position from which an object 60 corresponding to the other operation time for which a display start time nearest to (or equal to) the one operation time is set appears and moves.

In the example of FIG. 8, the display start time, the operation time, and the operational baseline portion are indicated so that a blue color object 60 is displayed on the first operational baseline portion 55A used by the first player as a baseline at the start time point (000) of the fourth beat in the first measure, and the object 60 moves from the first operational baseline portion 55A along the path W in order to arrive at the second operational baseline portion 55B at a time point after a time corresponding to “010” has elapsed from the start time point (000) of the fourth beat in the first measure. On the other hand, two objects 60 are displayed on the first operational baseline portion 55A at the start time point (000) of the first beat in the third measure. And, one object 60 moves to arrive at the second operational baseline portion 55B at a time point after a time corresponding to “010” has elapsed from the start time point of the first beat in the third measure. In contrast, the other object 60 moves to arrive at the second operational baseline portion 55B at a time point after a time corresponding to “015” has elapsed from the start time point of the first beat in the third measure. Further, an object 60 is also displayed on the second operational baseline portion 55B at the start time point (000) of the first beat in the third measure and the object 60 moves to arrive at the first operational baseline portion 55A at a time point after a time corresponding to “012” has elapsed from the start time point of the first beat in the third measure. That is, a total of three objects 60 are displayed at the start time point (000) of the first beat in the third measure.

In the example of FIG. 8, a correspondence relationship is indicated to the operation times associated with a common alphabetical character “A”, “B”, or “C”. That is, in the example of FIG. 8, a correspondence relationship is indicated so that a arrival position of an object 60, which is displayed on the first operational baseline portion 55A at the start time point (000) of the fourth beat in the first measure and arrives at the second operational baseline portion 55B at a time point after a time corresponding to “010” has elapsed from the start time point of the fourth beat in the first measure, functions as an appearing position of an object 60 which begins to be displayed on the second operational baseline portion 55B at a time point after a time corresponding to “010” has elapsed from the start time point of the fourth beat in the first measure and moves to arrive at the first operational baseline portion 55A at a time point after a time corresponding to “016” has elapsed from the start time point of the fourth beat in the first measure. In addition, although, in the example of FIG. 8, the display start time that is the same as the operation time is set between the operation times that have a correspondence relationship, the display start time may not be the same as the operation time. As long as the continuity of the object 60 can be maintained, for example, a time a little earlier than the operation time corresponding to the object 60 that arrives at the appearing position may be set as the display start time corresponding to the operation time that functions as the appearing position. Also, an operation time that functions as an appearing position may not be necessarily present between the operation times that have a correspondence relationship. The object 60 corresponding to an operation time including no operation time that functions as an appearing position may be deleted from the game area 50 assuming that the object 60 does not have continuity. When there are plural records that indicate the same operation time, one of the records that indicate the same operation time, such as a record having the earliest display start time or a record that appears earliest in the sequence data 28, is specified by a predetermined specification condition or the like, so that the object 60 (the object 60 that appears next) corresponding to another operation time may be specified. Information that associates the arrival position and the appearing position of the objects 60 with each other, such as information of the object 60 which is divided into plural objects 60, may be separately described on the sequence data.

The question data 29 is data in which a question text QT that should be displayed as a question, an answer text AT that should be displayed as an answer candidate to the question, and one of the selection buttons A to D are described in association with the operational baseline portion 55A and 55B. FIG. 9 is a diagram showing an example of the question data. In the example of FIG. 9, information of the operational baseline portion 55A and 55B, information of the selection buttons A to D, the text QT, and the text AT are sequentially described in a comma-delimited format. The answer text AT includes the first answer text AT1 and the second answer text AT2, which are also described in a comma-delimited format.

For example, the texts QT and AT are specified with by ASCII code. Each selection button A to D is specified by “A” to “D” to correspond to each selection button A to D on the game screen 50. For example, for a specification of the first selection button A1 on the side of the first operational baseline portion 55A and a specification of the first selection button A2 on the side of the second operational baseline portion 55B, “A” is described as the information of the selection button. The information of the operational baseline portion 55A and 55B is described in a comma-delimited format in the order of information of a question sender and information of a question receiver. The operational baseline portions 55A and 55B are specified by “P1” or “P2”. Specifically, when specifying the first operational baseline portion 55A corresponding to the first player, “P1” is described as the information of the operational baseline portion 55A and 55B. When specifying the second operational baseline portion 55B corresponding to the second player, “P2” is described as the information of the operational baseline portion 55A and 55B.

The example of FIG. 9 includes a description in which “P1” is indicated as the question sender, “P2” is indicated as the question receiver, “A” is indicated as the selection button, “How are you?” is indicated as the question text QT, “YES” is indicated as the first answer text AT1, and “NO” is indicated as the second answer text AT2. In the example of FIG. 9, the operational baselines portion 55A and 55B at which the texts QT and AT are displayed, the selection buttons A to D, and the texts QT and AT are indicated so that, when the first selection button A1 of the first operational baseline portion 55A specified as a question sender is touched, the text “How are you?” is displayed behind the object 60 that appears at the second operational baseline portion 55B specified as a question receiver, and further, when an appropriate touch operation is performed at the timing at which the object 60 arrives at the first operational baseline portion 55A, two objects 60 are displayed at the position at which the touch operation is performed and “YES” and “NO” are respectively displayed behind the two objects 60 moving toward the second operational baseline portion 55B. Therefore, the display of the object 60 is increased to two objects 60 as if the object 60 were divided into two objects 60 by not only the description of the sequence data 28, but also the operation of the selection buttons A to D. The two objects displayed by the operation of the selection buttons A to D move toward the operational baseline portion at which the two objects should arrive so that the two objects indicate the same operation time, that is, the operation time that should have been indicated by one object 60 if the selection buttons A to D had not been operated.

The sequence processing unit 15 of the game control unit 11 controls the display of the object 60 so that the specified operational baseline portion corresponds to the object 60 at the operation time specified by the sequence data 28 described above. The sequence processing unit 15 determines the assignment of the texts QT and AT of the question data 29 to the object 60 according to the touch operation performed on the selection buttons A to D while referring to the sequence data 28 and the question data 29. Specifically, according to the touch operation performed on one of the selection buttons A1 to D1 and A2 to D2, the sequence processing unit 15 determines a record in the question data 28 and determines the operational baseline portions 55A and 55B to which the texts QT and AT should be assigned on the basis of the determined record. Then, the sequence processing unit 15 assigns the texts QT and AT to the object 60 displayed at the operational baseline portion 55A or 55B determined after the touch operation performed on one of the selection buttons A1 to D1 and A2 to D2. At this time, the sequence processing unit 15 displays plural objects 60, which respectively indicate the same operation time as the operation time that should be indicated by the object to which the answer text is assigned, and the number the plural objects 60 is the same as the number of the answer texts.

Further, the sequence processing unit 15 sets behind the object to which the text QT or AT is assigned as an area for displaying each text of the question data 29, the text area TR extending along the path on which the object 60 moves. The sequence processing unit 15 displays the texts QT and AT respectively assigned to the objects 60 in the text areas TR respectively set behind the objects 60.

The sound output control unit 13 generates a sound reproduction signal according to the text QT or AT and reproduces the content of the text QT or AT as one of the sound effects from the speaker 14 when an appropriate operation is performed by the player.

Next, a process of the game control unit 11 when a music game is preformed on the game machine 1 will be described. When the game control unit 11 reads a game program 21 and completes initial setting necessary to perform the music game, the game control unit 11 stands by waiting for an instruction to start the game from the player. The instruction to start the game includes an operation for specifying data used in the game, such as selecting a piece of music to be played in the game and selecting a level of difficulty. The procedure for receiving the instruction may be the same as that of a known game.

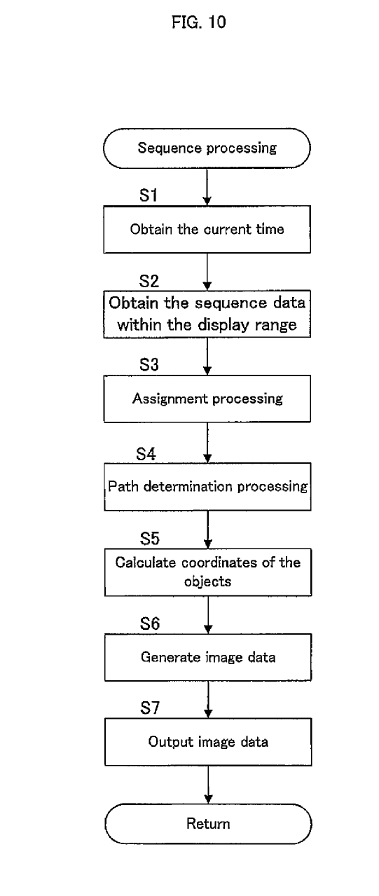

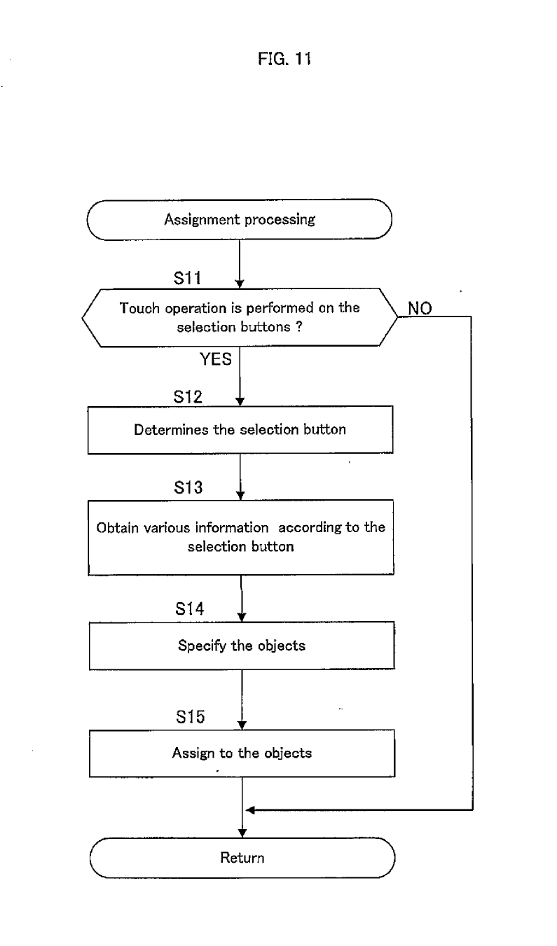

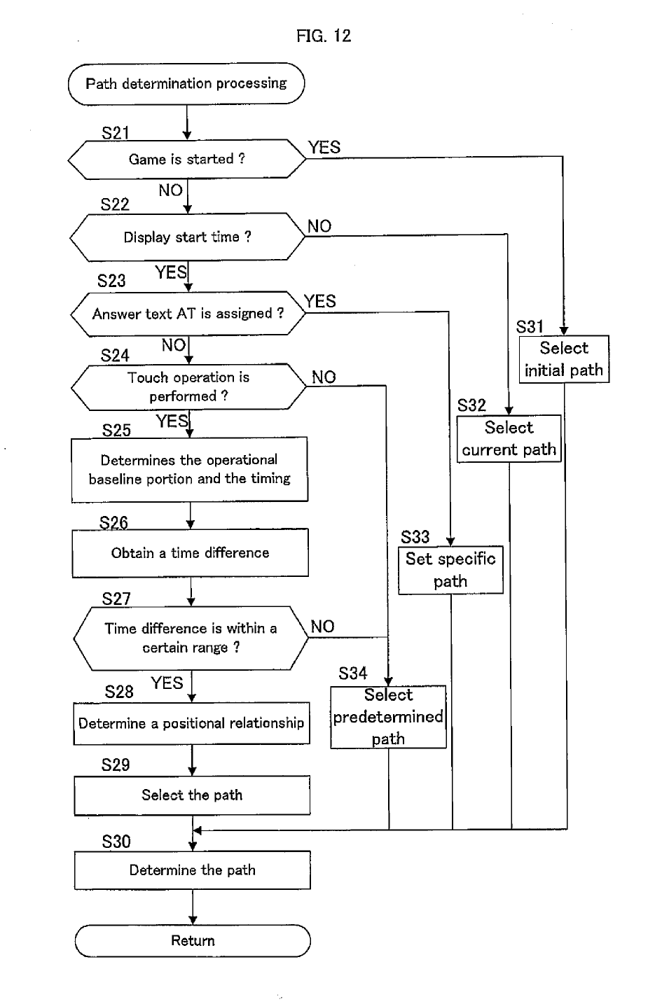

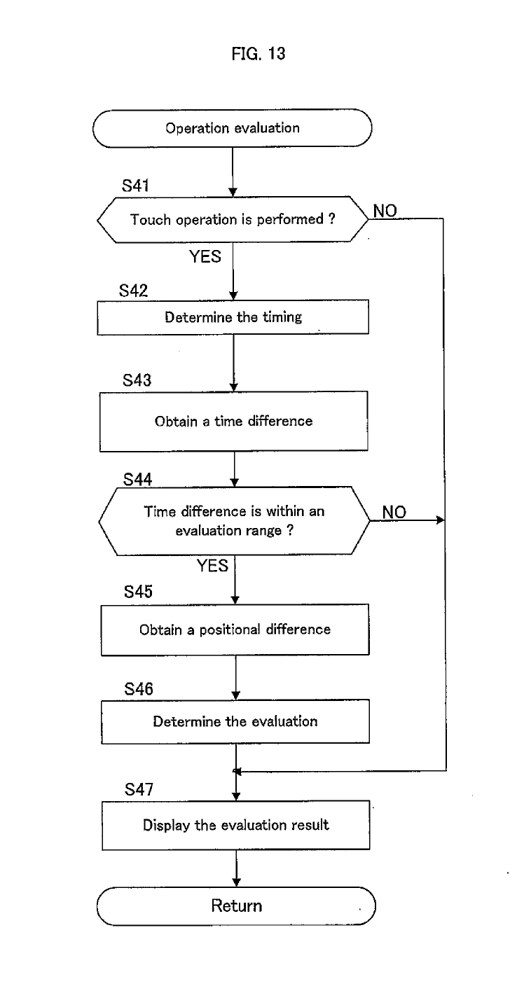

When the game is started, the game control unit 11 reads music data 25 corresponding to the piece of music selected by the player and outputs the music data 25 to the sound output control unit 13, and thereby the game control unit 11 starts the reproduction of the music from the speaker 14. Thereby, the control unit 10 functions as a music reproduction device. The game control unit 11 reads the sequence data 28 corresponding to the selection of the player, generates image data necessary to form the game area 52 and the information area 53 while referring to image data 27, and outputs the image data to the display control unit 12 in synchronization with the reproduction of the music, and thereby the game control unit 11 displays the game area 52 and the information area 53 on the monitor 3. Further, while the music game is being performed, the game control unit 11 repeatedly executes each of a sequence processing routine shown in FIG. 10, an assignment processing routine shown in FIG. 11, a path determination processing routine shown in FIG. 12, and an operation evaluation routine shown in FIG. 13 at a predetermined period as necessary processes to display the game area 52 and the like. In addition, the routines shown in FIGS. 10, 11, and 12 are executed by the sequence processing unit 15. The operation evaluation routine shown in FIG. 13 is executed by the operation evaluation unit 16

FIG. 10 shows an example of a flowchart of the sequence processing routine executed by the sequence processing unit 15. When the routine of FIG. 10 is started, the sequence processing unit 15 of the game machine 11 first obtains the current time on the music in step S1. For example, a timer operation is started by an internal clock of the game control unit 11 by using the reproduction start time point of the music as a reference and the current time is obtained from the value of the internal clock. In the next step S2, the sequence processing unit 15 obtains data of the display start time that is present in the time length corresponding to the display range of the game area 52 and the operation time from the sequence data 28. As an example, the display range is set in a time range corresponding to two measures of the music from the current time toward the future.

In the next step S3, the sequence processing unit 15 performs the assignment processing for assigning the texts QT and AT of the question data 29 to the objects 60. As an example, the assignment processing is executed by executing the routine of FIG. 11. FIG. 11 shows an example of a flowchart of the assignment processing routine executed by the sequence processing unit 15. When the routine of FIG. 10 is started, first, in step S11, the sequence processing unit 15 determines whether or not a touch operation is performed on one of the selection buttons A to D. In step S11, if the determination result is “YES”, the sequence processing unit 15 proceeds to step S12, and if the determination result is “NO”, the sequence processing unit 15 skips the subsequent processing and ends the routine.

In the next step S12, the sequence processing unit 15 refers to an output signal from the touch panel 5 and determines the selection button on which the touch operation is performed. In the next step S13, the sequence processing unit 15 obtains various information from the question data 29 according to the selection button on which the touch operation is performed. Specifically, in step S13, the sequence processing unit 15 refers to the question data 29 and obtains information of the question sender and the question receiver corresponding to one of the selection buttons A1 to D1 and A2 to D2 on which the touch operation is performed and information of the texts QT and AT. In the example of FIG. 9, if the sequence processing unit 15 determines that the touch operation is performed on the first selection button A1 provided on the side of the first operational baseline portion 55A, the sequence processing unit 15 obtains the first operational baseline portion 55A as the question sender and the second operational baseline portion 55B as the question receiver. Further, the sequence processing unit 15 obtains “How are you?” as the question text QT corresponding to the first selection button A1 provided on the side of the first operational baseline portion 55A and, “YES” and “NO” as the answer texts AT.

In the next step S14, the sequence processing unit 15 specifies the object 60 to which the obtained texts QT and AT should be assigned. As an example, the specification of the object 60 is performed as described below. First, the sequence processing unit 15 determines whether the question text QT should correspond to the object 60 that begins to be displayed on the operational baseline portion 55A or the object 60 that begins to be displayed on the operational baseline portion 55B on the basis of the information of the question receiver. Also, the sequence processing unit 15 determines whether the object 60 to which the question text QT is assigned should arrive at the operational baseline portion 55A or the operational baseline portion 55B and whether the answer text QT should correspond to the object 60 that begins to be displayed on the operational baseline portion 55A or the object 60 that begins to be displayed on the operational baseline portion 55B on the basis of the information of the question sender. Further, the sequence processing unit 15 determines the object 60, which moves from the operational baseline portion beginning the display of the object 60 to the operational baseline portion at which the object 60 should arrive, and which begins to be displayed earliest on the operational baseline portion from which the object 60 begins to be displayed after the touch operation is performed. The sequence processing unit 15 specifies the determined object 60 as the object 60 to which the question text QT should be assigned. Also, the sequence processing unit 15 determines whether the answer text AT should correspond to the object 60 that begins to be displayed on the operational baseline portion 55A or the object 60 that begins to be displayed on the operational baseline portion 55B on the basis of the information of the question sender. Further, the sequence processing unit 15 determines the object 60 which begins to be displayed on the determined operational baseline portion immediately after the object 60 to which the question text QT is assigned arrives at the determined operational baseline portion. The sequence processing unit 15 specifies the determined object 60 as the object 60 to which the answer text AT should be assigned.

In the next step S15, the sequence processing unit 15 assigns the texts QT and AT to the objects 60 specified in step S14 to which the texts QT and AT should be assigned and ends the routine.

Returning to FIG. 10, in the next step S4, the paths W of all the objects 60 are determined in association with the obtained operation times. As an example, the determination is performed by executing the routine of FIG. 12. FIG. 12 shows an example of a flowchart of the path determination processing executed by the sequence processing unit 15. When the routine of FIG. 12 is started, first, in step S21, the sequence processing unit 15 determines whether or not the game is started. In step S21, if the determination result is “YES”, the sequence processing unit 15 proceeds to step S31, and if the determination result is “NO”, the sequence processing unit 15 proceeds to step S22. In step S31, a predetermined initial path is selected as a path on which the object 60 should be displayed, and the sequence processing unit 15 proceeds to step S30. For an example, as the initial path, the path W3 which is included in the first operational baseline portion 55A and which extends from the rebound point R1 located at the nth position from the left is set in advance.

On the other hand, in step S22, the sequence processing unit 15 determines whether or not the display of the object 60 is the display for the display start time. In step S22, if the determination result is “NO”, that is, if the display of the object 60 is not the display for the display start time and the path that should be displayed has already been selected, the sequence processing unit 15 proceeds to step S32. In step S32, the sequence processing unit 15 selects the path that has already been selected as the path that should be displayed, that is, the current path (including the specific path described later), and the sequence processing unit 15 proceeds to step S30.

On the other hand, in step S22, if the determination result is “YES”, that is, if the display of the object 60 is the display for the display start time and the path that should be displayed is not selected, the sequence processing unit 15 proceeds to step S23. In step S23, the sequence processing unit 15 determines whether or not the object 60 that begins to be displayed is the object 60 to which the answer text AT is assigned in the routine of FIG. 11. In step S23, if the determination result is “NO”, the sequence processing unit 15 proceeds to step S24, and if the determination result is “YES”, that is, if the sequence processing unit 15 determines that the object 60 that begins to be displayed is the object 60 to which the answer text AT is assigned, the sequence processing unit 15 proceeds to step S33.

In step S33, the sequence processing unit 15 sets two predetermined different specific paths as the paths on which the object 60 is displayed, and proceeds to step S30. As the two different specific paths, for example, the first left path W1 and the first right path W3 which extend in contrasting directions with the linear path W2 in between are predetermined in advance.

In step S24, the sequence processing unit 15 refers to an output signal from the touch panel 5 and determines whether or not a touch operation is performed on the operational baseline portion 55A or 55B. In step S24, if the determination result is “NO”, the sequence processing unit 15 proceeds to step S34, and if the determination result is “YES”, the sequence processing unit 15 proceeds to step S25. In step S34, a predetermined path is selected as a path on which the object 60 should be displayed and the sequence processing unit 15 proceeds to step S30. For example, the selection of the predetermined path is implemented by setting a path adjacent to the path on which an object 60 corresponding to the object 60 that begins to be displayed, that is, an object 60 just arriving at the rebound point R1 or R2 used as the appearing position of the object 60 that begins to be displayed is displayed, or a path that has the shortest distance from the appearing position to the operational baseline portion 55A or 55B at which the object 60 should arrive.

On the other hand, in step S25, the sequence processing unit 15 determines the operational baseline portion on which the touch operation is performed on the basis of the output signal from the touch panel 5 and the timing (a time on the music) at which the touch operation is performed. In the next step S26, the sequence processing unit 15 determines one of the operation times described in the sequence data 28 which is nearest to the operation time of the touch operation on the operational baseline portion, that is one of the operation times associated on the sequence data 28 which is temporally nearest to the operation time of the touch operation on the operational baseline portion, and obtains a time difference between the operation time and the time at which the touch operation is performed.

In the next step S27, the sequence processing unit 15 determines whether or not the operation of the player is appropriate by determining whether or not the time difference is within a certain range. The certain range is obtained by setting a predetermined time range before and after the operation time to be compared. In step S27, if the determination result is “NO”, the sequence processing unit 15 proceeds to step S34, selects a predetermined path as the path on which the object 60 should be displayed as described above, and proceeds to step S30. On the other hand, if the determination result is “YES” in step S27, the sequence processing unit 15 proceeds to step S28.

In the next step S28, the sequence processing unit 15 determines a positional relationship between the operation position at which the touch operation is performed on the operational baseline portion 55A or 55B and the position of the object 60 on the basis of the output signal from the touch panel 5. Specifically, the sequence processing unit 15 selects and determines the position at which the touch operation is performed from the contact area S, the right area R, the left area L, and the other area O of the object 60 that has just arrived at the appearing position. In the next step S29, the sequence processing unit 15 selects the path on which the object 60 should be disposed according to the positional relationship determined in step S28. As an example, the selection of the path is performed as described below. First, the sequence processing unit 15 assigns one of the right area R, the left area L, or the contact area S and the other area O to each path W. Next, on the basis of the determination result of step S28, a path assigned to the position at which the touch operation is performed is selected from plural paths W extending from the appearing position. In the example of FIG. 3, at the rebound point R1, the linear path W2 is assigned to the contact area S and the other area O, the first right path W3 is assigned to the left area L, and the first left path W1 is assigned to the right area R. When the touch operation is performed near the contact area S or the other area O of the object 60, the linear path W2 is selected. When the touch operation is performed near the right area R, the first left path W1 is selected. When the touch operation is performed near the left area L, the first right path W3 is selected.

In the next step S30, the sequence processing unit 15 determines the path selected or set in step S29 and steps S31 to S34 as the path on which the object 60 is displayed and ends the routine.

Returning to FIG. 10, in the next step S5, the sequence processing unit 15 calculates coordinates of all the objects 60 that should be displayed on the paths W in the game area 52. As an example, the calculation is performed as described below. First, the sequence processing unit 15 determines the paths W on which each object 60 should be displayed on the basis of the result of step S4. Next, the sequence processing unit 15 determines the positions of the objects 60 in the time axis direction (that is, the moving direction of the object 60) from the operational baseline portion 55A or 55B according to the moving directions corresponding to the objects 60 (the operational baseline portion 55A or 55B at which the objects 60 should arrive) and the time difference between each operation time and the current time. In this case, if two different paths are set for the object 60 corresponding to one operation time, the positions on the two paths are respectively determined. Thereby, it is possible to obtain the paths W on which the objects 60 should be disposed and the coordinates of the objects 60 necessary to dispose the objects 60 on the paths W along the time axis from the operational baseline portion 55A or 55B.

In the next step S6, the sequence processing unit 15 generates image data necessary to form the game area 52 on the basis of the coordinates of the objects 60 calculated in step S5. Specifically, the sequence processing unit 15 generates the image data so that each object 60 is disposed at the calculated coordinates. In this case, if two different coordinate positions are calculated for the object 60 corresponding to one operation time, the sequence processing unit 15 disposes the objects 60 at the two coordinate positions respectively. Further, when the sequence processing unit 15 disposes the objects 60 to which the text QT or RT is assigned, the sequence processing unit 15 respectively sets the text areas TR behind the objects 60 and generates image data so that the assigned texts QT or AT are respectively displayed in the text areas TR. In this case, if two objects 60 corresponding to one operation time are displayed, that is, if the object 60 to which the answer text AT is assigned is displayed, two objects 60 are displayed. In this case, the sequence processing unit 15 generates image data so that the first answer text AT1 or the second answer text AT2 is displayed for each of the two objects 60. When assigning the answer text AT1 or AT2 to the two objects 60, for example, it is possible to set in advance so that the first answer text AT1 is assigned to the first left path W1 and the second answer text AT2 is assigned to the first right path W3, or the assignment may be determined by drawing lots using random sampling numbers. Also, the images of the object 60 and the like may be obtained from the image data 27.

In the next step S7, the sequence processing unit 15 outputs the image data to the display control unit 12. Thereby, the game area 52 is displayed on the monitor 3. After the processing of step S7, the sequence processing unit 15 ends the sequence processing routine. Since the processing described above is repeatedly performed, the object 60 is displayed at the display start time described in the sequence data 28 on the specified operational baseline portion 55A or 55B and the object 60 moves between the two operational baseline portion 55A and 55B so that the object 60 arrives at the specified operational baseline portion 55A or 55B at the operation time described in the sequence data 28. The object 60 to which the answer text AT is assigned is divided into two objects to which the first answer text AT1 and the second answer text AT2 are assigned respectively, and displayed. And, the text QT or AT is displayed behind the object 60 to which text QT or AT is assigned and the text QT or AT follows the object 60.

Next, the operation evaluation routine in FIG. 13 will be described. When the routine of FIG. 13 is started, first, in step S41, the operation evaluation unit 16 refers to the output signal from the touch panel 5 and determines whether or not a touch operation is performed on the object 60. At this time, if a position other than the operational baseline portion 55A or 55B is touched, it is determined that there is no touch operation. If there is no touch operation, the operation evaluation unit 16 ends the routine. If there is a touch operation, the operation evaluation unit 16 proceeds to step S42. In step S42, the operation evaluation unit 16 determines the timing (a time on the music) at which the touch operation is performed on the basis of the output signal from the touch panel 5. In the next step S43, the operation evaluation unit 16 specifies one of the operation times described in the sequence data 28 which is nearest to the operation time of the touch operation on the operational baseline portion, that is one of the operation times on the sequence data 28 which is temporally nearest to the operation time of the touch operation on the operational baseline portion, and obtains a time difference between the operation time and the time at which the touch operation is performed.

In the next step S44, the operation evaluation unit 16 determines whether or not the operation of the player is appropriate by determining whether or not the time difference is within an evaluation range. The evaluation range is obtained by setting a predetermined time range before and after the operation time to be compared. As an example, plural levels centered at the operation time are set, and a time range in which the levels are set is used as the evaluation range. In step S44, if the time difference is out of the evaluation range, the operation evaluation unit 16 ends the routine, and if the time difference is within the evaluation range, the operation evaluation unit 16 proceeds to step S45. In step S45, the operation evaluation unit 16 specifies the operation position at which the touch operation is performed on the operational baseline portion 55A or 55B, and one of the operation times on the sequence data 28 which is temporally nearest to the operation time related to the operational baseline portion on which the touch operation is performed, and obtains a positional difference between the operation position and the arrival position of the object 60 indicating the specified operation time.

In the next step S46, the operation evaluation unit 16 determines the evaluation of the touch operation of the player on the basis of the time difference obtained in step S44 and the positional difference obtained in step S45. As an example, the evaluation is performed as described below. First, the time difference is evaluated by determining the level to which the time of the touch operation belongs from the plural levels set in the time range. The plural levels are set by dividing the time range into segments at regular intervals. The nearer to the segment of the operation time the time of the touch operation belongs to, the higher the evaluation is. The positional difference is evaluated by comparing the center position of the object 60 and the position of the touch operation. For example, when evaluating the positional difference, an area within two times the diameter of the object 60 is evaluated as “GOOD”, and an area other than the above is evaluated as “MISS”. Or, an area within the outer circumference of the object 60 may be evaluated highest, and evaluation ranges are set so that every time the range is enlarged by a certain distance from the outer circumference, the evaluation may be degraded. And, the positional difference may be evaluated on the basis of the evaluation range to which the position of the touch operation belongs. In this case, the degree of difficulty of the game increases. Thereafter, the operation evaluation unit 16 proceeds to step S47, and controls an output to the display control unit 12 so that the evaluation result is displayed in at least either of the game area 52 and the information area 53. After completing the processing of step S47, the operation evaluation unit 16 ends the routine.

In addition, the step for obtaining the difference between the position of the object and the position of the touch operation in the example of FIG. 13 may be executed before the step for obtaining the difference between the most recent operation time on the operational baseline portion and the time at which the touch operation is performed. Although, in the example of FIG. 13, the positional difference is evaluated as “GOOD” or “MISS” according to the area, if the positional difference is out of a certain range, the operation evaluation unit 16 may skip the subsequent processing to end the routine in the same manner as in step S44. In this case, it is possible to ignore an operation to an inappropriate position out of a certain range, such as, for example, when an operation to the first operational baseline portion 55A is requested, an operation is performed on the second operational baseline portion 55B.

As described above, according to the game machine 1 of the embodiment, it is possible to select the movement path and the moving speed of the object 60 moving toward the next operational baseline portion by the touch operation. Thereby, one player can variously change the degree of difficulty of the game of the other player by an operation of the one player, so that it is possible to improve the interest of the game.

And, according to the game machine of the embodiment, it is possible to display a question text QT to the other player following the object 60 by an operation of the one player. Further, it is possible to display information of an answer candidate to the question text following the object 60 moving toward the other player as an answer text. Thereby, it is possible to exchange questions between players while executing a music game. As a result, it is possible to cause the object 60 to function as a device to display various information such as question information and answer information. Thereby, game elements can be added, so that the interest of the game can be enhanced.

In the above embodiment, the external storage device 20 of the game machine 1 functions as a music data storage device, a sequence data storage device, and a question data storage device. The control unit 10 functions as a game area display device, an indicator display control device, a text assignment determination device, and a text output device by causing the sequence processing unit 15 to execute the routines of FIGS. 10, 11, and 12. Further, the control unit 10 functions as an evaluation device by causing the operation evaluation unit 16 to execute the routine of FIG. 13.

The present invention is not limited to the above embodiment, however can be implemented in various embodiments. Although, in the above embodiment, a rectangular area is used as the game area 52, it is not limited to this. Areas of various shapes such as a polygonal shape and a circular shape may be used as the game area. Although, in the above embodiment, two operational baseline portions 55A and 55B are respectively provided at both ends of the game area 52 in the longitudinal direction, the number of the operational baseline portions is not limited to two. For example, an area around which three or more operational baseline portions are set may be used as the game area so that three or more players can play the game.

Although, in the above embodiment, a case in which there are three paths W extending from one rebound point R1 or R2 is illustrated, the number of the paths extending from each rebound point is not limited. Therefore, it is possible to set a large number of paths extending from each rebound point to all directions. There may be also a large number of the rebound points R1 and R2 included in the operational baseline portions 55A and 55B. In other words, plural paths may be provided so that the operation instruction indicator can move in all directions between all positions of the operational baseline portions. Further, there may be a large number of bounce points on both side walls 52R and 52L of the game area 52 and a large number of paths from the bounce points. Thereby, it is possible to set a large number of paths to the bounce points and a large number of paths from the bounce points. Although, in the above embodiment, the object 60 is divided into four areas and the movement path is determined by comparing the position of the touch operation and the four areas of the object, it is not limited to this. The operation instruction indicator may be divided into a large number of areas corresponding to a large number of paths provided in the game area. Thereby, the operation instruction indicator can be moved on arbitrary paths between the operational baseline portions corresponding to the touch operation. The operation instruction indicator is not limited to an indicator that is divided into plural areas. For example, the movement path of the operation instruction indicator may be determined by comparing a fixed position of the operation instruction indicator, such as the center position of the operation instruction indicator, with the position of the touch operation.

Although, in the above embodiment, the movement paths on which the operation instruction indicator moves are provided between the operational baseline portions, it is not limited to this. For example, the paths may extend to both ends of the game area beyond the operational baseline portions. In this case, it is possible to cause the operation instruction indicator to move to arrive at the operational baseline portion at the operation time described in the sequence data and also cause the operation instruction indicator to move to hit the end portion of the game area when an appropriate operation is not performed on the operation portion when the operation instruction indicator arrives at the operational baseline portion. In this case, the rebound points are also provided on the end portions of the game area and the position at which the operation instruction indicator arrives on the end portion of the game area may function as the appearing position of the next operation instruction indicator. Although, in the above embodiment, the object 60 disappears at the position at which the object 60 arrives and the arrival position functions as the appearing position of the object 60 corresponding to the operation time at which a common object 60 is indicated, so that the object 60 moves as if the object 60 rebounds between the operational baseline portion 55A and 55B, the movement of the object 60 is not limited to this. For example, the operation instruction indicator may not disappear at the rebound point every time the operation instruction indicator arrives at the rebound point. The operation instruction indicator may actually rebound at the rebound point by continuously using a common object 60. In this case, for example, after the operation instruction indicator rebounds at the rebound point, the color of the operation instruction indicator is changed to a color corresponding to the operational baseline portion at which the operation instruction indicator should arrive next time, so that it is possible to indicate the operational baseline portion to which the operation instruction indicator moves.

Although, in the above embodiment, the movement path on which the object 60 moves to the next operational baseline portion is determined according to the positional relationship between the position of the touch operation and the position of the object 60, the determination of the movement path is not limited to the method based on such a positional relationship. For example, the movement path may be determined on the basis of an operation in which the positions of the touch operations indicate a continuously changing direction.

Although, in the above embodiment, the movement path of the object 60 changes according to the touch operation, the movement path is not limited to a path that changes according to the operation of the player. For example, the movement path may be changed by the development and effects of the game. In other words, the movement path of the object may be changed by a predetermined condition such as an operation to the operation portion and the development and effects of the game. As an example in which the movement path of the object 60 is changed as effects of the game, the movement path of the object 60 may be determined according to a time interval between an operation time and the next operation time. For example, as one of predetermined conditions, the movement range of the operation instruction indicator is limited by an option prepared along the development of the game, and the movement path may be changed by the limitation. Or, the moving speed of the operation instruction indicator is accelerated by an option prepared along the development of the game, and thereby the movement path may be changed. Further, the movement path may be changed so that the moving speed is changed according to the level of the player.

Although, in the above embodiment, selection buttons A to D and texts are described in the question data 29 in association with each other, the present invention is not limited to an embodiment including buttons for selecting the question text QT. For example, the selection of the question text QT or the assignment of the texts QT and AT to the object 60 may be performed on the basis of a predetermined operation to the operational baseline portion 55A or 55B.

Although, in the above embodiment, the texts QT and AT and information of the selection buttons A-D are described in the question data 29 in association with the operational baseline portion 55A or 55B, the question data 29 is not limited to the above embodiment. For example, as a predetermined operation to display the texts QT and AT, an operation for indicating the moving direction of the object 60 to be a specific direction and indicating the moving speed to be higher than a certain speed may be used. Also, for example, the texts and a time on the music corresponding to the operation time may be described in association with each other. In this case, the object 60 and the text information can be associated with each other by using the time on the music as a key. In addition, in this case, the sequence data functions as also the question data. Further, for example, the question data and the object 60 may be associated with each other for convenience of the development of the game such as an option in the game. In other words, the assignment of the texts QT and AT is not limited to be executed corresponding to a predetermined operation such an operation of the selection buttons A to D, but the assignment may be executed by a predetermined condition such as convenience of the game.

Although, in the above embodiment, the question text QT and the answer text AT are prepared in the question data in advance, it is not limited to this. For example, the player may input the question text and the answer text when the game is started, or the player may select and set the question text and the answer text from question data and answer data, a large number of which are prepared.

Although, in the above embodiment, the text area TR is set behind the object 60, it is not limited to this. For example, the text area TR may be set in front of the object 60 or the text area TR may be set in parallel with the object 60. Or, the object 60 itself may be used as the text area TR. Further, the text area TR is not limited to an area that moves along with the object 60, and for example, the text area may be separately set at a fixed position.

In the above embodiment, objects 60 displayed with the answer texts AT are displayed corresponding to the arrival of the object 60 displayed with the question text QT. In other words, the question text QT and the answer texts AT are displayed for the continuous objects 60. Thereby, the question text QT is displayed for the object 60 that arrives at the side of one player who sends the question, however, it is not limited to this. For example, the assignment of the texts QT and AT may be performed so that a normal object 60 for which the text QT or AT is not displayed is included between the object 60 for which the question text QT is displayed and the object 60 for which the answer text AT is displayed, and both the question text QT and the answer text AT move toward the other player who receives the question.

The question text QT and the answer text AT may be displayed only to a player who sets the question or a player who answers the question. Thereby, when the game is played by plural players, it is possible to conceal the information from players other than the player concerned, such as the player who sets the question or the player who answers the question. Although, in the above embodiment, as the operation instruction indicators to which the answer texts are assigned, the operation instruction indicators corresponding to the number of the answers appear from when the operation instruction indicators appear on the baseline portion, it is not limited to this. For example, while the operation instruction indicator is moving toward the next baseline portion, the operation instruction indicator is divided so that the number of the operation instruction indicators increases to the number corresponding to the number of the answers, and the answer texts may be respectively assigned to the increased operation instruction indicators. In this case, the question text may be displayed for the operation instruction indicator before being divided. In other words, the same operation instruction indicator is used as the operation instruction indicator to which the question text is assigned and the operation instruction indicator to which the answer text is assigned, and the displayed text may be changed while the operation instruction indicator is moving. The operation instruction indicator to which the question text is assigned and the operation instruction indicators to which the answer text are assigned begin to be displayed at the same time on the same baseline portion, and the operation instruction indicator to which the question text is assigned may arrive earlier at the baseline portion of the player who answers the question. In other words, the operation instruction indicator to which the question text or the answer text should be assigned is not limited to an operation instruction indicator that moves back and forth between the baseline portions. Therefore, the question text and the answer text may be freely assigned to the operation instruction indicators as long as the question text is displayed earlier than the answer texts and the answer texts are operation instruction indicators that move toward the player who receives the question, that is, the side of the player who answers the question, and arrive at the baseline portion later than the question text.

In the above embodiment, plural answer texts are assigned to one operation time. Therefore, plural operation instruction indicators respectively corresponding to plural answer texts are displayed, and the operation instruction indicators arrives at the baseline portion at the same time to indicate the same operation time, however, it is not limited to this. For example, the plural answer texts may be assigned to plural operation times (any of them corresponds to the answerer) respectively corresponding to the answer texts. In other words, the operation instruction indicators respectively corresponding to plural answer texts may arrive at the baseline portion at different times to indicate different operation times. In this case, among the operation instruction indicators respectively corresponding to plural answer texts, since operation instruction indicators that are not appropriate as the answer are not operated, the operation times that should be evaluated decreases. The evaluation value for operations corresponding to appropriate answer texts may be adjusted according to the number of the answer texts. For example, if two answer texts are assigned to two operation instruction indicators that move to indicate different operation times, the evaluation value of one operation instruction indicator that is evaluated appropriately as an appropriate answer may be doubled as the adjustment described above. Thereby, it is possible to provide a benefit of reduction of the operation instruction indicators to be operated to the answerer as an incentive for the load of answer. On the other hand, if the answerer refuses to answer the question, that is, if the answerer does not perform an appropriate operation on any of the answer texts, the load that the evaluation value is degraded two times or the like is provided to the answerer. Thereby, the motivation of the answerer to answer the question can be improved. Therefore, it is possible to provide to the questioner, a benefit to easily obtain the answer for a question difficult to answer. The plural answer texts may be assigned to the operation times corresponding to the operation instruction indicators that continuously arrive at the baseline portion corresponding to the answerer (not including an operation instruction indicator that arrives at the baseline portion of the questioner between the operation times) as different operation times. In this case, since arrival times of the operation instruction indicators respectively corresponding to the plural answer texts occur continuously, the relationship between the answer texts can be emphasized.

Although, in the above embodiment, the operation time of the touch operation is evaluated by being compared with the operation times described in the sequence data by the control unit 10 that functions as the evaluation device, the function as the evaluation device may be omitted. In this case, the game machine can be used as a match-up type game machine in which one player induces mistakes of the other player while operating with rhythm of the music.

Although, in the above embodiment, a touch panel is used as the input device, the input device is not limited to a touch panel. For example, there can be used input devices having various configurations can be used as long as the input device has plural operation portions, such as a controller provided with plural push buttons as operation portions.

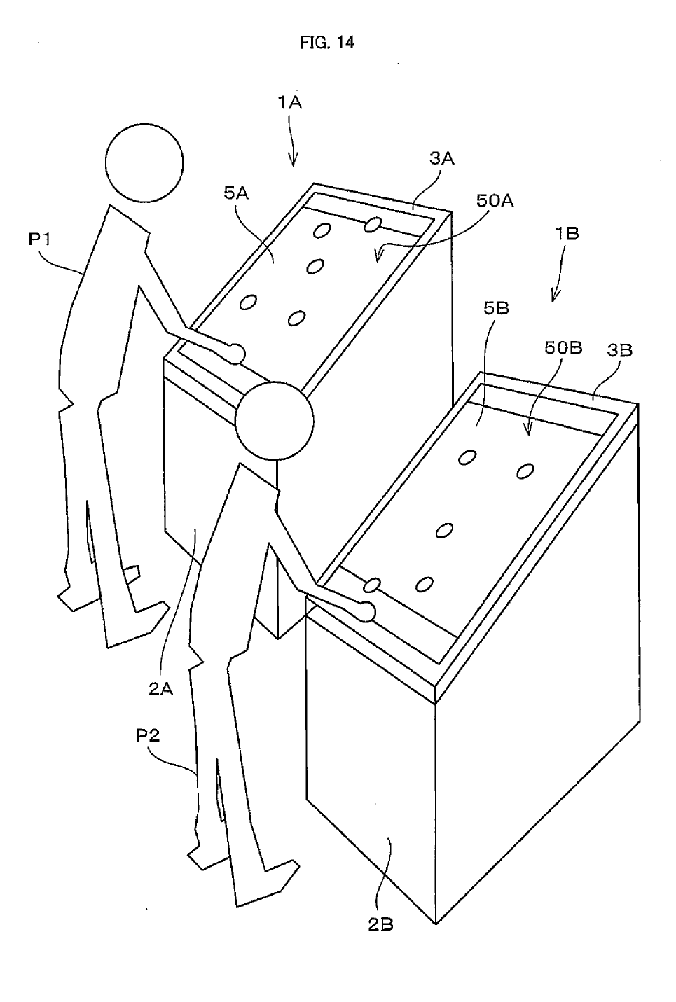

Although, in the above embodiment, only one game machine 1 is shown in FIG. 1, plural game machines 1 may be connected to each other so that the game machines 1 can share the content of the game. FIG. 14 is a diagram showing a state in which two game machines 1A and 1B are connected to each other so that the game machines can share the content of the game. As shown in FIG. 14, the first operational baseline portion 55A is arranged on the side of the first player P1 in the monitor 3A used by the first player P1, and the second operational baseline portion 55B is arranged on the side of the second player P2 in the monitor 3B used by the second player P2. In other words, the game screen 50A on which the first player P1 plays is arranged vertically opposite to the game screen 50B on which the second player P2 plays. The first player P1 uses the first operational baseline portion 55A through the touch panel 5A laminated on the monitor 3A as the operation portion and the second player uses the second operational baseline portion 55B through the touch panel 5B laminated on the monitor 3B as the operation portion. In this case, the first operational baseline portion 55A of the first game machine 1A and the second operational baseline portion 55B of the second game machine 1B function as each of plural operation portions. The arrangement is not limited to that shown in FIG. 14, and for example, the two game machines 1 may be arranged so that the back surfaces of the two game machines 1 face each other, that is, the two game machines 1 are arranged back to back. In this case, since the game can be performed while the players face each other, the feeling of each player that one player is fighting with the other player can be improved. Although, in the above embodiment, the monitor 3 is tilted to face the player P, it is not limited to this. For example, the monitor may be arranged to be substantially horizontal. In this case, since one monitor is used by two players, the first operational baseline portion 55A and the second operational baseline portion 55B can be used as plural operation portions by two the players through a shared monitor and a shared touch panel.

Although, in the above embodiment, plural players or the game machine itself function as the other player, and thereby a game played by plural players is performed, it is not limited to this. As a game system according to a modified example of the present invention, for example, the game performed in the game machine 1 may be a game in which only the first operational baseline portion 55A is set to be used as the operation portion and the second operational baseline portion 55B is arranged to simply function as a wall for bouncing the operation instruction indicator. And, only the first operational baseline portion 55A is provided in the game screen, and the game is performed so that, while the operation instruction indicator rebounds on the wall provided as a baseline portion along the boundary of the game area, the operation instruction indicator moves to arrive only at the first operational baseline portion 55A described in the sequence data, or moves to arrive at the first operational baseline portion 55A and a wall located in a position opposing the first operational baseline portion 55A (or another wall). In this case, it is possible to realize a one-person game capable of variously changing the degree of difficulty of the game. In this case, the first operational baseline portion 55A and the wall arranged in a position opposing the first operational baseline portion 55A or the like function as plural baseline portions of the present invention. A baseline time is used instead of the operation time as a time described in the sequence data and a time of the baseline time at which the operation instruction indicator arrives at the first operational baseline portion 55A functions as the operation time. In this case, the question and the answer may be displayed on the basis of the question text and the answer text that are described in association with the sequence data in advance. Specifically, the game performed by the game machine 1 in this case may be configured to display the question behind the operation instruction indicator moving from the first operational baseline portion 55A to the other wall at a predetermined operation time (a condition such as a predetermined operation may be added) described in the sequence data, display the operation instruction indicators corresponding to the number of the answer candidates which moves toward the first operational baseline portion 55A in order to indicate the same operation time on the wall or the like arranged in a position opposing the first operational baseline portion 55A at which the operation instruction indicator arrives and, display the answer texts behind these operation instruction indicators. Thereby, it is possible to realize setting of a question and requesting of an answer even when a single player plays.

Although, in the above embodiment, the game machine 1 is configured as a music game machine in which music is reproduced and the operation instruction indicator moves toward the operational baseline portion on the basis of the playing time of the music, it is not limited to this. In the game machine 1, for example, it is possible to perform various games, such as a flag-raising game for instructing a character having flags in his or her both hands on the game screen to raise one of the flags to a certain position, as long as the operation time is indicated with an image or a voice. Further, the game system of the present invention may be implemented as an arbitrary embodiment such as an arcade game machine installed in commercial facilities, a floor-standing type game machine for family use, a mobile game machine, and a game system realized using a network.

What is claimed is:

1. A game system comprising:
a display device that displays and outputs a game screen;
an input device having at least one operation portion;
a sequence data storage device that stores sequence data in which an operation time to the operation portion during a game is described;
a question data storage device that stores question data in which one question text that should be displayed to a player and at least one answer texts corresponding to the question text are described in association with each other;
a game area display device that displays a game area in which plural baseline portions arranged at a distance away from each other are set on a game screen of the display device;
an indicator display control device that moves and displays an operation instruction indicator for indicating an operation to the operation portion in the game area so that the operation instruction indicator arrives at least one of the baseline portions at an operation time indicated by the sequence data;
a text assignment determination device that determines operation instruction indicators to which the question text and the answer text described in the question data should be respectively assigned according to a predetermined condition; and
a text output device that outputs at least one of the question text and the answer text that should be assigned to the operation instruction indicators determined by the text assignment determination device in association with the operation instruction indicators.

2. The game system according to claim 1, wherein the text output device realizes the associated output by respectively displaying the question text and the answer text in predetermined position in the game area so that the operation instruction indicators determined by the text assignment determination device and at least one of the question text and the answer text that should be assigned to the operation instruction indicators have a predetermined positional relationship with each other.

3. The game system according to claim 2, wherein the text output device sets a text area for displaying either the question text or the answer text, and arranges the text area in a position behind the operation instruction indicator to which at least one of the question text and the answer text is assigned as the predetermined position.

4. The game system according to claim 3, wherein the text output device move the text area so as to follow the operation instruction indicator in front of the text area.

5. The game system according to claim 1, wherein the text assignment determination device determines a predetermined operation inputted into the input device as the predetermined condition, and determines the operation instruction indicators to which the question text and the answer text should be respectively assigned by using the predetermined operation.

6. The game system according to claim 1, wherein the input device is provided with plural operation portions,
operation times to each of the plural operation portions during the game and information indicating one of the plural operation portions are described in association with each other in the sequence data,
the game area display device displays a game area in which the plural baseline portions is set respectively so as to correspond to the plural operation portions on the game screen of the display device, and
the indicator display control device moves and displays the operation instruction indicator in the game area so that the operation instruction indicator arrives at the baseline portion corresponding to the operation portion associated with the operation time indicated by the sequence data at the operation time.

7. The game system according to claim 6, wherein the input device is further provided with at least one specific operation instruction portion for each of the operation portions,
the question text is described in association with the specific operation instruction portion in the question data so that it is possible to determine which operation portion of the operation portions the question text corresponds to, and
the text assignment determination device uses an operation to the specific operation instruction portion as the predetermined condition, determines the question text and the baseline portion corresponding to the specific operation instruction portion on which the operation is performed on the basis of the question data, and determines an operation instruction indicator that arrives at the baseline portion corresponding to the specific operation instruction portion after the operation is performed on the specific operation instruction portion as the operation instruction indicator to which the question text corresponding to the specific operation instruction portion should be assigned.

8. The game system according to claim 7, wherein the answer text and information indicating one of the baseline portions are described in association with each other in the question data,
the text assignment determination device determines an operation instruction indicator to which the question text should be assigned and determines a baseline portion at which an operation instruction indicator to which the answer text is assigned should arrive on the basis of the question data, and determines an operation instruction indicator that arrives at the baseline portion at which the operation instruction indicator to which the answer text is assigned should arrive after the operation instruction indicator to which the question text is assigned arrives at the baseline portion at which the operation instruction indicator to which the question text is assigned should arrive as the operation instruction indicator to which an answer text corresponding to the question text should be assigned.

9. The game system according to claim 1, wherein plural answer texts are described in association with one of the question texts in the question data.

10. The game system according to claim 9, wherein the text assignment determination device determines one operation instruction indicator as the operation instruction indicator to which the plural answer texts should be assigned,
the indicator display control device increases and displays the one operation instruction indicator determined by the text assignment determination device to plural operation instruction indicators which corresponds to the number of the answer texts, and which move on paths different from each other and arrive at the same baseline portion at the same operation time, and
the text output device respectively associates and outputs the answer texts assigned to the one operation instruction indicator with the operation instruction indicators increased by the indicator display control device.

11. The game system according to claim 1, wherein a touch panel arranged on the display device to cover the game area is used as the input device.

12. The game system according to claim 1, wherein the game area display device displays an area which is formed into a rectangular shape and in which two baseline portions extending linearly are set at both ends of the rectangular shape to face each other as the game area on the screen of the display device.

13. The game system according to claim 1, further comprising an evaluation device that evaluates an operation on at least one operation portion on the basis of a time of the operation to the operation portions and the operation time specified by the sequence data.

14. The game system according to claim 1, further comprising:
an audio output device that output game audio;
a music data storage device that stores music data for reproducing music; and
a music reproduction device that reproduces the music from the audio output device on the basis of the music data; and wherein
an operation time of the operation portion during reproduction of the music is described in the sequence data.

15. The game system according to claim 14, wherein the text output device reproduces the question text or the plural answer texts assigned to each operation instruction indicator from the audio output device when the player performs an appropriate operation in accordance with a contact between the operation instruction indicator to which at least one of the question text and the answer text is assigned and the baseline portion.

16. A control method of controlling a computer which is incorporated in a game system comprising: a display device that displays and outputs a game screen; an input device having at least one operation portion; a sequence data storage device that stores sequence data in which an operation time to the operation portion during a game is described; a question data storage device that stores question data in which one question text that should be displayed to a player and at least one answer texts corresponding to the question text are described in association with each other; wherein the control method of controlling the computer comprises the steps:
a game area display step that displays a game area in which plural baseline portions arranged at a distance away from each other are set on a game screen of the display device;
an indicator display control step that moves and displays an operation instruction indicator for indicating an operation to the operation portion in the game area so that the operation instruction indicator arrives at least one of the baseline portions at an operation time indicated by the sequence data;
a text assignment determination step that determines operation instruction indicators to which the question text and the answer text described in the question data should be respectively assigned according to a predetermined condition; and
a text output step that outputs at least one of the question text and the answer text that should be assigned to the operation instruction indicators determined by the text assignment determination step in association with the operation instruction indicators.

17. A computer program for a game system comprising: a display device that displays and outputs a game screen; an input device having at least one operation portion; a sequence data storage device that stores sequence data in which an operation time to the operation portion during a game is described; a question data storage device that stores question data in which one question text that should be displayed to a player and at least one answer texts corresponding to the question text are described in association with each other; wherein the computer program is configured to make a computer incorporated in the game system serve as:
a game area display device that displays a game area in which plural baseline portions arranged at a distance away from each other are set on a game screen of the display device;
an indicator display control device that moves and displays an operation instruction indicator for indicating an operation to the operation portion in the game area so that the operation instruction indicator arrives at least one of the baseline portions at an operation time indicated by the sequence data;
a text assignment determination device that determines operation instruction indicators to which the question text and the answer text described in the question data should be respectively assigned according to a predetermined condition; and
a text output device that outputs at least one of the question text and the answer text that should be assigned to the operation instruction indicators determined by the text assignment determination device in association with the operation instruction indicators.
